(19) United States
(12) Patent Application Publication
(10) Pub. No.: US 2022/0214544 A1
(43) Pub. Date: Jul. 7, 2022

(54) PROJECTION IMAGE DISPLAYING MEMBER, WINDSHIELD GLASS, AND HEAD-UP DISPLAY SYSTEM

(71) Applicant: FUJIFILM Corporation, Tokyo (JP)

(72) Inventor: Akihiro ANZAI, Minamiashigara-shi (JP)

(73) Assignee: FUJIFILM Corporation, Tokyo (JP)

(21) Appl. No.: 17/700,666

(22) Filed: Mar. 22, 2022

Related U.S. Application Data
(63) Continuation of application No. PCT/JP2020/036123, filed on Sep. 24, 2020.

(30) Foreign Application Priority Data
Sep. 27, 2019 (JP) 2019-177963

(51) Int. Cl. G02B 27/01; B60R 1/00; G02F 1/1335; G02F 1/13363

(52) U.S. Cl. CPC G02B 27/0101; B60R 1/001; B60R 2300/205; G02F 1/133636; G02B 2027/0196; G02F 1/133543

(57) ABSTRACT

An object is to provide a projection image displaying member that enables display of a projection image using p-polarized light and can provide a head-up display system having high polarizing sunglasses suitability, a windshield, and a head-up display system. The object is achieved by a projection image displaying member having a transparent substrate having an in-plane retardation of 5000 nm or more and at least one selective reflection layer, wherein the selective reflection layer is located closer to the side on which projection light is incident than the transparent substrate is.

### CROSS-REFERENCE TO RELATED APPLICATIONS

This application is a Continuation of PCT International Application No. PCT/JP2020/036123 filed on Sep. 24, 2020, which claims priority under 35 U.S.C. § 119(a) to Japanese Patent Application No. 2019-177963 filed on Sep. 27, 2019. The above application is hereby expressly incorporated by reference, in its entirety, into the present application.

### BACKGROUND OF THE INVENTION

### 1. Field of the Invention

The present invention relates to a projection image displaying member, a windshield glass having the projection image displaying member, and a head-up display system using the windshield glass.

### 2. Description of the Related Art

So-called head-up displays (head-up display systems), which project a screen image on a windshield glass of a vehicle or the like to provide information to a driver, are known. In the following description, a head-up display is also referred to as a “HUD”. HUD is an abbreviation of “head-up display”.

A HUD allows a driver to obtain various information such as a map, a driving speed, and a vehicle state without widely moving the line of sight while seeing the outside front view, and thus the driver is expected to drive more safely while obtaining various information.

As is well known, in the reflection of light, the highest reflectivity is achieved when s-polarized light is incident at a Brewster's angle.

Accordingly, the HUD displays a projection image typically in a manner that an s-polarized projection image is projected from a projector, and the s-polarized projection image is allowed to be incident on a windshield glass at an angle close to the Brewster's angle and reflected by the windshield glass.

The driver often drives with sunglasses on. Known sunglasses include polarizing sunglasses that reduce light interfering with driving such as glare due to reflected light from, for example, a puddle on the road and glare due to reflected light from a hood.

In many cases, glaring light that dazzles the driver, such as glare due to reflected light from, for example, a puddle on the road, is s-polarized light. Thus, polarizing sunglasses are typically made to block s-polarized light.

However, as described above, projection light of the HUD is mostly s-polarized light. Thus, in the case of a standard HUD, a projection image cannot be observed when polarizing sunglasses are worn.

A commonly used vehicle windshield glass is a so-called laminated glass formed of two glass plates bonded to each other with a film called an intermediate film.

In a HUD in which a projection image is reflected by a windshield glass that is a laminated glass, projection light reflected by the glass plate on the vehicle interior side forms a projection image to be observed. However, projection light transmitted through the glass on the vehicle interior side is reflected also by the glass plate on the vehicle exterior side, resulting in a double image.

To eliminate such a double image, in a HUD in which s-polarized light is incident on a windshield glass, the windshield glass needs to be a so-called wedge-shaped laminated glass formed of two glass plates bonded to each other at an angle.

To overcome these problems, a HUD using a half-mirror film that reflects p-polarized light has also been proposed. This HUD displays a projection image in a manner that p-polarized projection light is projected from a projector, and the p-polarized projection light is reflected by a half-minor film incorporated in, for example, a windshield glass.

For example, WO2016/056617A discloses a half-mirror film (light reflecting film) including at least two light reflecting layers that are laminated, the at least two light reflecting layers including at least one of light reflecting layers among a light reflecting layer PRL-1, a light reflecting layer PRL-2, and a light reflecting layer PRL-3, the light reflecting layer PRL-1 having a central reflection wavelength of greater than or equal to 400 nm but less than 500 nm and a reflectance to ordinary light at the central reflection wavelength of greater than or equal to 5% but less than or equal to 25%, the light reflecting layer PRL-2 having a central reflection wavelength of greater than or equal to 500 nm but less than 600 nm and a reflectance to ordinary light at the central reflection wavelength of greater than or equal to 5% but less than or equal to 25%, the light reflecting layer PRL-3 having a central reflection wavelength of greater than or equal to 600 nm but less than 700 nm and a reflectance to ordinary light at the central reflection wavelength of greater than or equal to 5% but less than or equal to 25%, the at least two light reflecting layers having central reflection wavelengths that are different from each other, all of the at least two light reflecting layers that are laminated having a property of reflecting polarized light that has the same orientation.

JP2017-187685A discloses a curved half-mirror film (light reflecting film) including at least two light reflecting layers that are laminated, the at least two light reflecting layers including at least one of light reflecting layers among a light reflecting layer PRL-1, a light reflecting layer PRL-2, and a light reflecting layer PRL-3, the light reflecting layer PRL-1 having a central reflection wavelength of greater than or equal to 400 nm but less than 500 nm in a flat state and a reflectance to ordinary light at the central reflection wavelength of greater than or equal to 5% but less than or equal to 25%, the light reflecting layer PRL-2 having a central reflection wavelength of greater than or equal to 500 nm but less than 600 nm in a flat state and a reflectance to ordinary light at the central reflection wavelength of greater than or equal to 5% but less than or equal to 25%, the light reflecting layer PRL-3 having a central reflection wavelength of greater than or equal to 600 nm but less than 700 nm in a flat state and a reflectance to ordinary light at the central reflection wavelength of greater than or equal to 5% but less than or equal to 25%, the at least two light reflecting layers having central reflection wavelengths that are different from each other, all of the at least two light reflecting layers that are laminated having a property of reflecting polarized light that has the same orientation, all of the at least two light reflecting layers that are laminated retaining a curved shape in an unloaded state, the half-mirror film having a thickness of greater than or equal to 50 μm but less than or equal to 500 μm.

WO2016/056617A and JP2017-187685A each state that the half-mirror film is used in a HUD.

### SUMMARY OF THE INVENTION

The half-mirror films disclosed in WO2016/056617A and JP2017-187685A are, for example, each incorporated into a windshield glass to constitute a HUD.

The half-mirror films disclosed in WO2016/056617A and JP2017-187685A reflect p-polarized light. Thus, according to a HUD using such a half-mirror film and a projector that projects a p-polarized projection image, the projection image can be observed even when polarizing sunglasses that block s-polarized light are worn. In addition, since projection light is not reflected by glass plates, the windshield glass need not be wedge-shaped in order to eliminate a double image.

As described above, light that dazzles the driver and interferes with driving, such as glare due to reflected light from, for example, a puddle on the road, is s-polarized light in many cases.

However, when a windshield film having a half-mirror film that reflects p-polarized light is used, s-polarized light that has entered from the vehicle exterior side of a windshield glass undergoes a change in polarization when passing through a light-reflecting film in the windshield glass, resulting in the coexistence of a p-polarized light component. Since polarizing sunglasses block s-polarized light as described above, the p-polarized light component is transmitted through the polarizing sunglasses. Thus, in the case of the HUD that displays a projection image with p-polarized light, the function of the polarizing sunglasses to block the glare of the above-described reflected light composed mainly of s-polarized light may be impaired, thus interfering with driving.

An object of the present invention is to provide a projection image displaying member that can provide a HUD having high polarizing sunglasses suitability, a windshield glass having the projection image displaying member, and a HUD using the windshield glass.

To achieve the above object, the present invention has the following configuration.

[1] A projection image displaying member has a transparent substrate having an in-plane retardation of 5000 nm or more and at least one selective reflection layer. The selective reflection layer is located closer to a side on which projection light is incident than the transparent substrate is.

[2] The projection image displaying member according to [1] has a polarization conversion layer that converts linearly polarized light into circularly polarized light or changes a polarization direction of linearly polarized light.

The transparent substrate, the selective reflection layer, and the polarization conversion layer are disposed in this order.

[3] In the projection image displaying member according to [2], the polarization conversion layer is a phase difference layer having an in-plane phase difference of 100 to 450 nm at a wavelength of 550 nm.

[4] In the projection image displaying member according to [2], the polarization conversion layer is a layer formed by fixing a helical alignment structure of a liquid crystal compound twistedly aligned along a helical axis extending in a thickness direction.

[5] In the projection image displaying member according to [4], at least one of (i) or (ii) is satisfied:

0.2≤x≤1.5 (i)

1.0≤y≤5.0 (ii)

where x is a pitch number of the helical alignment structure, and y is a thickness (μm) of the polarization conversion layer.

[6] In the projection image displaying member according to any one of [1] to [5], the selective reflection layer is a cholesteric liquid crystal layer formed by fixing a cholesteric liquid crystalline phase.

[7] In the projection image displaying member according to any one of [1] to [6], an angle formed by incident s-polarized light and a slow axis of the transparent substrate is 10° to 30°.

[8] A windshield glass has a first glass plate and a second glass plate that are bonded together and the projection image displaying member according to any one of [1] to [7].

[9] In the windshield glass according to [8], the projection image displaying member is disposed between the first glass plate and the second glass plate.

[10] In the windshield glass according to [8], the projection image displaying member is bonded to a surface of the first glass plate facing away from the second glass plate.

[11] In the windshield glass according to any one of [8] to [10], the first glass plate is on a vehicle interior side, and the projection image displaying member is disposed such that the transparent substrate is closer to the second glass plate than the selective reflection layer is.

[12] In the windshield glass according to any one of [8] to [11], an angle formed by a horizontal direction in a mounted state and a slow axis of the transparent substrate of the projection image displaying member is 10° to 30°.

[13] A head-up display system has the windshield glass according to any one of [8] to [12] and a projector that projects p-polarized projection light onto the windshield glass.

According to the present invention, a projection image displaying member that can provide a HUD having high polarizing sunglasses suitability, a windshield glass having the projection image displaying member, and a HUD using the windshield glass are provided.

### BRIEF DESCRIPTION OF THE DRAWINGS

FIG. 1 schematically illustrates an example of a projection image displaying member of the present invention;

FIG. 2 is a schematic diagram for explaining the action of a transparent substrate;

FIG. 3 is a schematic diagram for explaining the action of a transparent substrate;

FIG. 4 is a schematic diagram for explaining the action of a transparent substrate;

FIG. 5 schematically illustrates an example of a windshield glass of the present invention;

FIG. 6 schematically illustrates another example of a windshield glass of the present invention;

FIG. 7 schematically illustrates another example of a windshield glass of the present invention;

FIG. 8 schematically illustrates an example of a HUD of the present invention; and

FIG. 9 is a schematic diagram for explaining a method of forming an alignment film.

### DESCRIPTION OF THE PREFERRED EMBODIMENTS

Hereinafter, a projection image displaying member, a windshield glass, and a HUD (head-up display system) of the present invention will be described in detail on the basis of preferred examples illustrated in the accompanying drawings.

In this specification, “to” is meant to include the numerical values before and after “to” as the lower and upper limits.

In this specification, visible light is a type of electromagnetic radiation that has wavelengths visible to the human eye and is in the wavelength range of 380 to 780 nm. Non-visible light is light in the wavelength range of less than 380 nm or the wavelength range of more than 780 nm. Among visible light, light in the wavelength range of 420 to 490 nm is blue light (B light), light in the wavelength range of 495 to 570 nm is green light (G light), and light in the wavelength range of 620 to 750 nm is red light (R light), although these values are not limitative. Furthermore, infrared light refers to non-visible light in the wavelength range of more than 780 nm and 2000 nm or less, although these values are not limitative.

In this specification, p-polarized light refers to polarized light that oscillates in a direction parallel to the plane of incidence of light. The plane of incidence refers to a plane that is vertical to the plane of reflection and that includes incident light and reflected light. In the p-polarized light, the plane of oscillation of an electric field vector is parallel to the plane of incidence.

In this specification, in-plane retardations Re (in-plane phase differences) are measured using an AxoScan manufactured by Axometrics. Unless otherwise specified, the measurement wavelength is 550 nm.

In this specification, the term “projection image” refers to an image based on the projection of light from a projector used, but not a surrounding view such as a front view. The projection image is observed as a virtual image that emerges in an area ahead of a projection image displaying section of a windshield glass when viewed from a viewer.

In this specification, the term “screen image” refers to an image displayed on a drawing device of a projector or an image drawn on, for example, an intermediate image screen by the drawing device. As opposed to the virtual image, the screen image is a real image.

In this specification, the term “visible light transmittance” refers to a transmittance of visible light from an A light source, which is defined in JIS R 3212:2015 (Test methods of safety glazing materials for road vehicles). That is, the visible light transmittance is a transmittance determined by measuring the transmittance at wavelengths in the range of 380 to 780 nm with a spectrophotometer using an A light source, multiplying the transmittance at each wavelength by the weighting function obtained from the wavelength distribution and wavelength interval of the CIE (International Commission on Illumination) photopic luminous efficiency function, and calculating a weighted average.

In this specification, a liquid crystal composition and a liquid crystal compound conceptually include those which no longer exhibit liquid crystallinity as a result of curing or the like.

### Projection Image Displaying Member

The projection image displaying member of the present invention is a half mirror (half-mirror film) that reflects projection light carrying a screen image (projection image) and displays, with the reflected projection light, the screen image carried by the projection light as a projection image.

The projection image displaying member has a visible light-transmitting property. Specifically, the visible light transmittance of the projection image displaying member is preferably 80% or more, more preferably 82% or more, still more preferably 84% or more. Due to such a high visible light transmittance, a visible light transmittance that meets the standards of a vehicle windshield glass can be achieved even when the projection image displaying member is combined with a glass having a low visible light transmittance to form a laminated glass.

The projection image displaying member preferably does not exhibit substantial reflection in a wavelength range with high luminosity.

Specifically, for light in the normal direction, a standard laminated glass and a laminated glass including the projection image displaying member preferably exhibit substantially the same reflection at or near a wavelength of 550 nm. In particular, they preferably exhibit substantially the same reflection in a visible light wavelength range of 490 to 620 nm.

The phrase “substantially the same reflection” means that the difference in reflectivity of natural light (unpolarized light) at a predetermined wavelength measured in the normal direction with, for example, a spectrophotometer such as a “V-670” spectrophotometer manufactured by JASCO Corporation is 10% or less. In the above wavelength range, the difference in reflectivity is preferably 5% or less, more preferably 3% or less, still more preferably 2% or less, particularly preferably 1% or less.

When substantially the same reflection is exhibited in a wavelength range with high luminosity, a visible light transmittance that meets the standards of a vehicle windshield glass can be achieved even when the projection image displaying member is combined with a glass having a low visible light transmittance to form a laminated glass.

The projection image displaying member may be in the form of, for example, a thin film or a thin sheet. Before being used in a windshield glass, the projection image displaying member may be in the form of, for example, a rolled thin film.

The projection image displaying member only needs to have a half-mirror function for at least part of projected light. Therefore, the projection image displaying member need not function as a half mirror for, for example, every light in the visible light range.

The projection image displaying member may have the above half-mirror function for light at all incidence angles but only needs to have the above half-mirror function for light at at least some incidence angles.

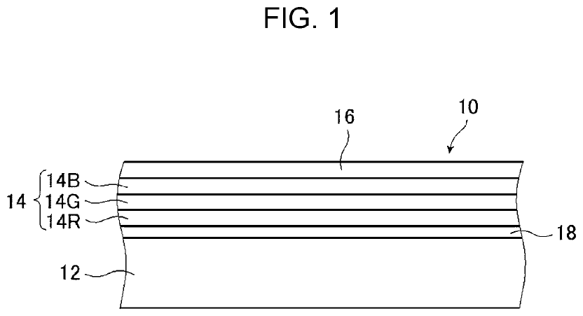

FIG. 1 schematically illustrates an example of the projection image displaying member of the present invention.

As illustrated in FIG. 1, a projection image displaying member 10 has a transparent substrate 12, a selective reflection layer 14, a polarization conversion layer 16, and an adhesive layer 18.

The projection image displaying member 10 of the present invention is a half-mirror film for reflecting projection light to display a projection image and is used in a HUD in combination with a windshield glass, for example.

In the projection image displaying member 10 of the present invention, the selective reflection layer 14 is disposed closer to the side on which projection light is incident than the transparent substrate 12 is. That is, in the case of the projection image displaying member illustrated in FIG. 1, the polarization conversion layer 16 serves as the plane of incidence of projection light.

Therefore, when the projection image displaying member 10 of the present invention is mounted in a HUD or the like, the selective reflection layer 14 is on the vehicle interior side, and the transparent substrate 12 side is the vehicle exterior side. That is, projection light of the HUD is incident on the selective reflection layer 14 (the polarization conversion layer 16) side and is reflected. On the other hand, external light from outside the vehicle is incident on the transparent substrate 12, transmitted through the adhesive layer 18, the selective reflection layer 14, and the polarization conversion layer 16, and reaches the interior of the vehicle, for example.

In the projection image displaying member 10 of the present invention, the transparent substrate 12 is transparent and has an in-plane retardation Re of 5000 nm or more.

The transparent substrate 12 is a characteristic member in the projection image displaying member of the present invention.

The transparent substrate 12 will be described later in detail.

### Adhesive Layer

The adhesive layer 18 is for bonding the transparent substrate 12 and the selective reflection layer 14 to each other.

The adhesive layer 18 may be a layer made of an adhesive that is fluid at the time of affixing and then becomes solid, a layer made of a pressure-sensitive adhesive that is a gel-like (rubber-like) soft solid at the time of affixing and keeps being gel-like after being affixed, or a layer made of a material having characteristics of both an adhesive and a pressure-sensitive adhesive.

According to the type of setting, adhesives are classified into hot melt adhesives, thermosetting adhesives, photosetting adhesives, reaction-setting adhesives, and pressure-sensitive adhesives requiring no setting. Examples of usable materials for these adhesives include compounds such as acrylate compounds, urethane compounds, urethane acrylate compounds, epoxy compounds, epoxy acrylate compounds, polyolefin compounds, modified olefin compounds, polypropylene compounds, ethylene vinyl alcohol compounds, vinyl chloride compounds, chloroprene rubber compounds, cyanoacrylate compounds, polyamide compounds, polyimide compounds, polystyrene compounds, and polyvinyl butyral compounds. From the viewpoint of workability and productivity, the type of setting is preferably photosetting. From the viewpoint of optical transparency and heat resistance, the material is preferably, for example, an acrylate compound, a urethane acrylate compound, or an epoxy acrylate compound.

The adhesive layer 18 may be formed using an OCA (optical clear adhesive). The OCA may be a commercially available product for a screen image display device, particularly, a commercially available product for a surface of a screen image display unit of a screen image display device. Examples of such commercially available products include adhesive sheets (e.g., PD-S1) manufactured by PANAC Co., Ltd. and MHM adhesive sheets manufactured by Nichieikako Co., Ltd.

The adhesive layer 18 may have any thickness. The thickness of the adhesive layer 18 is preferably 0.5 to 10 μm, more preferably 1.0 to 5.0 μm. The thickness of the adhesive layer 18 formed using an OCA may be 10 to 50 μm and is preferably 15 to 30 μm.

If the selective reflection layer 14 can be formed directly on the transparent substrate 12 with sufficient adhesion, the adhesive layer 18 is unnecessary.

### Selective Reflection Layer

The selective reflection layer 14 is a layer that wavelength-selectively reflects light. Specifically, the selective reflection layer 14 is a layer that selectively reflects light in a particular wavelength range.

In the illustrated example, the selective reflection layer 14 selectively reflects light in a predetermined wavelength range and transmits other light.

The selective reflection layer 14 is preferably a polarized light reflection layer. The polarized light reflection layer is a layer that reflects linearly polarized light, circularly polarized light, or elliptically polarized light.

The polarized light reflection layer is preferably a circularly polarized light reflection layer or a linearly polarized light reflection layer. The circularly polarized light reflection layer is a layer that reflects circularly polarized light having one sense (rotational direction) and transmits circularly polarized light having the other sense in a selective reflection wavelength range. The linearly polarized light reflection layer is a layer that reflects linearly polarized light in one polarization direction and transmits linearly polarized light in a polarization direction orthogonal to the reflecting polarization direction at a selective reflection center wavelength.

The polarized light reflection layer can transmit unreflected polarized light. Therefore, using the polarized light reflection layer allows light to be partly transmitted even in the wavelength range in which the selective reflection layer 14 exhibits reflection.

The selective reflection layer 14 is preferably a circularly polarized light reflection layer, particularly preferably a cholesteric liquid crystal layer formed by fixing a cholesteric liquid crystalline phase.

As a preferred example, the selective reflection layer 14 of the projection image displaying member 10 illustrated in the figure has three selective reflection layers: a red-reflecting cholesteric liquid crystal layer 46R having a selective reflection center wavelength in the red light wavelength range, a green-reflecting cholesteric liquid crystal layer 46G having a selective reflection center wavelength in the green light wavelength range, and a blue-reflecting cholesteric liquid crystal layer 46B having a selective reflection center wavelength in the blue light wavelength range.

The projection image displaying member 10 illustrated in the figure performs reflection of red light, green light, and blue light so as to be equipped for a full-color projection image, but the present invention is not limited to this configuration.

In the present invention, the selective reflection layer 14 of the projection image displaying member may have the red-reflecting cholesteric liquid crystal layer 46R and the green-reflecting cholesteric liquid crystal layer 46G alone, the red-reflecting cholesteric liquid crystal layer 46R and the blue-reflecting cholesteric liquid crystal layer 46B alone, or the green-reflecting cholesteric liquid crystal layer 46G and the blue-reflecting cholesteric liquid crystal layer 46B alone, so as to be equipped for a two-color projection image. Alternatively, the selective reflection layer 14 may have only one of the red-reflecting cholesteric liquid crystal layer 46R, the green-reflecting cholesteric liquid crystal layer 46G, and the blue-reflecting cholesteric liquid crystal layer 46B, so as to be equipped for monochrome projection light.

That is, in the projection image displaying member of the present invention, basically, when projection light projected by the projector of a HUD is a full-color image, the selective reflection layer 14 is configured to reflect all of blue light, green light, and red light. When projection light projected by the projector of a HUD is a two-color image, the selective reflection layer 14 is configured to reflect the same two colors. When projection light projected by the projector of a HUD is a monochrome image, the selective reflection layer 14 is configured to reflect the same color.

### Cholesteric Liquid Crystal Layer (Circularly Polarized Light Reflection Layer)

A cholesteric liquid crystal layer means a layer formed by fixing a cholesteric liquid crystalline phase.

The cholesteric liquid crystal layer may be any layer in which the alignment of a liquid crystal compound forming a cholesteric liquid crystalline phase is maintained. Typically, the cholesteric liquid crystal layer may be a layer that is formed by bringing a polymerizable liquid crystal compound into the state of cholesteric liquid crystalline phase alignment and then polymerizing and curing the compound, for example, by ultraviolet irradiation and heating, so that the layer has no fluidity and at the same time undergoes no change in its alignment state when acted upon by an external field or an external force. In the cholesteric liquid crystal layer, it is only necessary that the optical properties of the cholesteric liquid crystalline phase be maintained in the layer, and the liquid crystal compound in the layer need not exhibit liquid crystallinity. For example, the polymerizable liquid crystal compound may lose its liquid crystallinity as a result of an increase in molecular weight due to curing reaction.

The cholesteric liquid crystalline phase is known to exhibit circularly polarized light selective reflection, that is, to selectively reflect circularly polarized light having one sense, either right-handed circularly polarized light or left-handed circularly polarized light, and transmit circularly polarized light having the other sense.

As films including layers in which such cholesteric liquid crystalline phases that exhibit circularly polarized light selective reflection are fixed, many films formed of compositions including polymerizable liquid crystal compounds have been known. The cholesteric liquid crystal layer can be found in the related art.

The center wavelength of selective reflection (selective reflection center wavelength) of the cholesteric liquid crystal layer depends on the helical pitch P (=helical period) of the helical structure (helical alignment structure) in a cholesteric liquid crystalline phase and satisfies the relation λ=n×P, where n is an average refractive index of the cholesteric liquid crystal layer. As is clear from this formula, the selective reflection center wavelength can be controlled by adjusting the n value and/or the P value.

In other words, the helical pitch P (one helical pitch) of the helical structure is a length of one turn of the helix in the helical axis direction. That is, the helical pitch P is a length in the helical axis direction where a director (the longitudinal direction in the case of a rod-like liquid crystal) of the liquid crystal compound forming the cholesteric liquid crystalline phase rotates 360°. The helical axis direction of a typical cholesteric liquid crystal layer is identical to the thickness direction of the cholesteric liquid crystal layer.

When a section of the cholesteric liquid crystal layer is observed under a scanning electron microscope (SEM), a streak pattern derived from the cholesteric liquid crystalline phase and having bright lines (bright portions) and dark lines (dark potions) alternating with each other in the thickness direction is observed.

The helical pitch P of the cholesteric liquid crystal layer is twice the distance between the bright lines. In other words, the helical pitch P of the cholesteric liquid crystal layer is equal to the length of three bright lines and two dark lines in the thickness direction, that is, the length of three dark lines and two bright lines in the thickness direction. This length is the center-to-center distance between the upper and lower bright or dark lines in the thickness direction.

The selective reflection center wavelength and the half-width (full width at half maximum) of the cholesteric liquid crystal layer can be determined, for example, as described below.

A reflection spectrum of the cholesteric liquid crystal layer is measured in the normal direction using a spectrophotometer (manufactured by JASCO Corporation, V-670). In the reflection spectrum, a peak of transmittance decrease is observed in the selective reflection region. Of two wavelengths at the middle (average) transmittance between the minimum transmittance of this peak and the transmittance before decrease, the shorter wavelength is defined as λₗ (nm), and the longer wavelength as λₕ (nm). The selective reflection center wavelength λ and the half-width Δλ can be expressed by the following formula.

λ=(λ₁+λₕ)/2Δλ=(λₕ−λₗ)

The selective reflection center wavelength determined as described above is substantially equal to the wavelength at the barycentric position of the reflection peak of the circularly polarized light reflection spectrum measured in the normal direction of the cholesteric liquid crystal layer.

The helical pitch of the cholesteric liquid crystalline phase depends on the type of chiral agent used together with the polymerizable liquid crystal compound and the concentration of the chiral agent added, and thus the desired pitch can be achieved by controlling the type and the concentration. The sense and pitch of a helix can be measured by using methods described in page 46 of “Ekisho Kagaku Jikken Nyumon (Introduction of Liquid Crystal Chemical Experiments)” edited by The Japanese Liquid Crystal Society, published by SIGMA SHUPPAN, 2007 and page 196 of “Handbook of Liquid Crystals” edited by the Editorial Board of the Handbook of Liquid Crystals, published by Maruzen Co., Ltd.

In the projection image displaying member, cholesteric liquid crystal layers are preferably disposed, from the projection light incident side, in the order of layers having shorter selective reflection center wavelengths.

Each cholesteric liquid crystal layer has either a right-handed or left-handed helical sense. The sense of circularly polarized light (the rotational direction of circularly polarized light) reflected by the cholesteric liquid crystal layers is identical to the helical sense.

Preferably, the plurality of cholesteric liquid crystal layers having different selective reflection center wavelengths have the same helical sense, that is, reflect circularly polarized light having the same rotational direction.

The half-width Δλ (nm) of a selective reflection band in which selective reflection is exhibited depends on the birefringence Δn of the liquid crystal compound and the pitch P described above and satisfies the relation Δλ=Δn×P. Thus, the width of the selective reflection band can be controlled by adjusting Δn. The adjustment of Δn can be performed by adjusting the types or mixing ratio of polymerizable liquid crystal compounds or by controlling the temperature during alignment fixation.

To form cholesteric liquid crystal layers of the same type having the same selective reflection center wavelength, a plurality of cholesteric liquid crystal layers having the same pitch P and the same helical sense may be laminated. By laminating cholesteric liquid crystal layers having the same pitch P and the same helical sense, the selectivity of circularly polarized light at a particular wavelength can be increased.

The plurality of cholesteric liquid crystal layers constituting the selective reflection layer 14 may be formed by laminating separately formed cholesteric liquid crystal layers by using an adhesive or the like or by applying a liquid crystal composition (coating liquid) including a polymerizable liquid crystal compound and the like directly onto a surface of a cholesteric liquid crystal layer previously formed by a method described later and repeating alignment and fixing steps. The latter is preferred.

This is because by forming the next cholesteric liquid crystal layer directly on a surface of the previously formed cholesteric liquid crystal layer, the alignment direction of liquid crystal molecules of the previously formed cholesteric liquid crystal layer on the air interface side and the alignment direction of the liquid crystal molecules on the lower side of the cholesteric liquid crystal layer formed on the previously formed cholesteric liquid crystal layer become coincident with each other, thus providing a laminate of cholesteric liquid crystal layers with good polarization properties. In addition, uneven interference that may occur due to an uneven thickness of the adhesive layer will not be observed.

The thickness of each cholesteric liquid crystal layer is preferably 0.2 to 10 μm, more preferably 0.5 to 10 μm, still more preferably 1.0 to 8.0 μm, particularly preferably 1.5 to 6.0 μm.

The total thickness of the cholesteric liquid crystal layers is preferably 2.0 to 30 μm, more preferably 2.5 to 25 μm, still more preferably 3.0 to 20 μm.

### Method for Producing Cholesteric Liquid Crystal Layer

Hereinafter, materials and a method for producing the cholesteric liquid crystal layer will be described.

Examples of materials used to form the cholesteric liquid crystal layer described above include a liquid crystal composition including a polymerizable liquid crystal compound and a chiral agent (optically active compound). The liquid crystal composition, which may optionally be mixed with, for example, a surfactant and a polymerization initiator and dissolved in a solvent or the like, is applied to, for example, a support, an alignment film, or a cholesteric liquid crystal layer to serve as an underlayer. After cholesteric alignment is matured, the alignment is fixed by curing the liquid crystal composition, whereby a cholesteric liquid crystal layer can be formed.

### Polymerizable Liquid Crystal Compound

The polymerizable liquid crystal compound may be a rod-like liquid crystal compound or a disk-like liquid crystal compound, and is preferably a rod-like liquid crystal compound.

The rod-like polymerizable liquid crystal compound for forming the cholesteric liquid crystal layer may be, for example, a rod-like nematic liquid crystal compound. Preferred examples of rod-like nematic liquid crystal compounds include azomethines, azoxies, cyanobiphenyls, cyanophenyl esters, benzoic acid esters, cyclohexanecarboxylic acid phenyl esters, cyanophenyl cyclohexanes, cyano-substituted phenylpyrimidines, alkoxy-substituted phenylpyrimidines, phenyldioxanes, tolans, and alkenyl cyclohexyl benzonitriles. Not only low-molecular-weight liquid crystal compounds but also high-molecular-weight liquid crystal compounds can be used.

The polymerizable liquid crystal compound is obtained by introducing a polymerizable group into a liquid crystal compound. Examples of the polymerizable group include unsaturated polymerizable groups, an epoxy group, and an aziridinyl group. Unsaturated polymerizable groups are preferred, and ethylenically unsaturated polymerizable groups are particularly preferred. The polymerizable group can be introduced into molecules of a liquid crystal compound by various methods. The number of polymerizable groups in one molecule of the polymerizable liquid crystal compound is preferably 1 to 6, more preferably 1 to 3.

Examples of the polymerizable liquid crystal compound include compounds described in Makromol. Chem., vol. 190, p. 2255 (1989), Advanced Materials, vol. 5, p. 107 (1993), U.S. Pat. Nos. 4,683,327A, 5,622,648A, 5,770,107A, WO95/022586A, WO95/024455A, WO97/000600A, WO98/023580A, WO98/052905A, JP1989-272551A (JP-H1-272551A), JP1994-016616A (JP-H6-016616A), JP1995-110469A (JP-H7-110469A), JP1999-080081A (JP-H11-080081A), and JP2001-328973A. Two or more polymerizable liquid crystal compounds may be used in combination. Combined use of two or more polymerizable liquid crystal compounds enables alignment at lower temperatures.

The amount of polymerizable liquid crystal compound in the liquid crystal composition is preferably 80 to 99.9 mass %, more preferably 85 to 99.5 mass %, still more preferably 90 to 99 mass %, relative to the mass of solids (the mass excluding the mass of solvent) in the liquid crystal composition.

To improve the visible light transmittance, the cholesteric liquid crystal layer may have low Δn. The cholesteric liquid crystal layer having low Δn can be formed by using a low-Δn polymerizable liquid crystal compound. Hereinafter, the low-Δn polymerizable liquid crystal compound will be specifically described.

### Low-Δn Polymerizable Liquid Crystal Compound

A cholesteric liquid crystalline phase is formed by using a low-Δn polymerizable liquid crystal compound and fixed to form a film, whereby a narrow-band selective reflection layer can be obtained. Examples of the low-Δn polymerizable liquid crystal compound include compounds described in WO2015/115390, WO2015/147243, WO2016/035873, JP2015-163596A, and JP2016-053149A. For liquid crystal compositions that provide selective reflection layers having small half-widths, reference can be made to the description in WO2016/047648.

The liquid crystal compound may be a polymerizable compound in WO2016/047648 represented by formula (I) below.

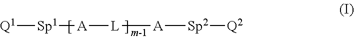

In formula (I), A represents an optionally substituted phenylene group or an optionally substituted trans-1,4-cyclohexylene group, L represents a linking group selected from the group consisting of a single bond, —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—, m represents an integer of 3 to 12, Sp¹ and Sp² each independently represent a linking group selected from the group consisting of a single bond, a linear or branched alkylene group having 1 to 20 carbon atoms, and a group in which one or more than one —CH₂-moiety in a linear or branched alkylene group having 1 to 20 carbon atoms is substituted with —O—, —S—, —NH—, —N(CH₃)—, —C(═O)—, —OC(═O)—, or —C(═O)O—, and Q¹ and Q² each independently represent a hydrogen atom or a polymerizable group selected from the group consisting of groups represented by formula Q-1 to formula Q-5 below, provided that one of Q¹ and Q² represents a polymerizable group.

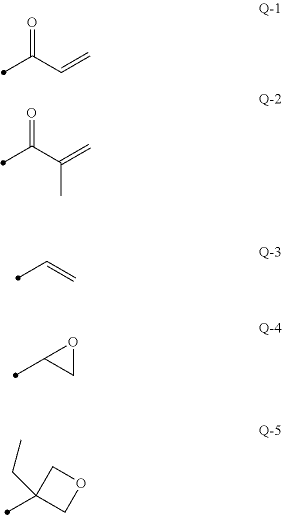

The phenylene group in formula (I) is preferably a 1,4-phenylene group.

The substituents in the “optionally substituted” phenylene group and the “optionally substituted” trans-1,4-cyclohexylene group are not particularly limited, and examples include an alkyl group, a cycloalkyl group, an alkoxy group, an alkyl ether group, an amide group, an amino group, a halogen atom, and a substituent selected from the group consisting of groups obtained by combining two or more of these substituents. Examples of the substituents also include substituents represented by —C(═O)—X³-Sp³-Q³, which will be described later. The phenylene group and the trans-1,4-cyclohexylene group may have 1 to 4 substituents. When these groups have two or more substituents, the two or more substituents may be the same or different.

The alkyl group may be a linear or branched alkyl group. The number of carbon atoms of the alkyl group is preferably 1 to 30, more preferably 1 to 10, still more preferably 1 to 6. Examples of the alkyl group include a methyl group, an ethyl group, a n-propyl group, an isopropyl group, a n-butyl group, an isobutyl group, a sec-butyl group, a tert-butyl group, a n-pentyl group, an isopentyl group, a neopentyl group, a 1,1-dimethylpropyl group, a n-hexyl group, an isohexyl group, a linear or branched heptyl group, an octyl group, a nonyl group, a decyl group, an undecyl group, and a dodecyl group. The above description regarding the alkyl group also applies to the alkoxy group, which includes an alkyl group. Specific examples of the alkylene group include divalent groups obtained by removing any one hydrogen atom from each of the above examples of the alkyl group. Examples of the halogen atom include a fluorine atom, a chlorine atom, a bromine atom, and an iodine atom.

The number of carbon atoms of the cycloalkyl group is preferably 3 to 20, more preferably 5 or more, and preferably 10 or less, more preferably 8 or less, still more preferably 6 or less. Examples of the cycloalkyl group include a cyclopropyl group, a cyclobutyl group, a cyclopentyl group, a cyclohexyl group, a cycloheptyl group, and a cyclooctyl group.

The substituent that the phenylene group and the trans-1,4-cyclohexylene group may have is particularly preferably a substituent selected from the group consisting of an alkyl group, an alkoxy group, and —C(═O)—X³-Sp³-Q³. Here, X³ represents a single bond, —O—, —S—, or —N(Sp⁴-Q⁴)-, or represents a nitrogen atom that forms a ring structure together with Q³ and Sp³. Sp³ and Sp⁴ each independently represent a linking group selected from the group consisting of a single bond, a linear or branched alkylene group having 1 to 20 carbon atoms, and a group in which one or more than one —CH₂— moiety in a linear or branched alkylene group having 1 to 20 carbon atoms is substituted with —O—, —S—, —NH—, —N(CH₃)—, —C(═O)—, —OC(═O)—, or —C(═O)O—.

Q³ and Q⁴ each independently represent a hydrogen atom, a cycloalkyl group, a group in which one or more than one —CH₂— moiety in a cycloalkyl group is substituted with —O—, —S—, —NH—, —N(CH₃)—, —C(═O)—, —OC(═O)—, or —C(═O)O—, or a polymerizable group selected from the group consisting of the groups represented by formula Q-1 to formula Q-5.

Specific examples of the group in which one or more than one —CH₂— moiety in a cycloalkyl group is substituted with —O—, —S—, —NH—, —N(CH₃)—, —C(═O)—, —OC(═O)—, or —C(═O)O— include a tetrahydrofuranyl group, a pyrrolidinyl group, an imidazolidinyl group, a pyrazolidinyl group, a piperidyl group, a piperazinyl group, and a morpholinyl group. The substitution position is not particularly limited. Of these, a tetrahydrofuranyl group is preferred, and a 2-tetrahydrofuranyl group is particularly preferred.

In formula (I), L represents a linking group selected from the group consisting of a single bond, —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—. L is preferably —C(═O)O— or —OC(═O)—. L in the number of m−1 may be the same or different.

Sp¹ and Sp² each independently represent a linking group selected from the group consisting of a single bond, a linear or branched alkylene group having 1 to 20 carbon atoms, and a group in which one or more than one —CH₂— moiety in a linear or branched alkylene group having 1 to 20 carbon atoms is substituted with —O—, —S—, —NH—, —N(CH₃)—, —C(═O)—, —OC(═O)—, or —C(═O)O—. Sp¹ and Sp² are preferably each independently a linear alkylene group that has 1 to 10 carbon atoms and has terminals to each of which a linking group selected from the group consisting of —O—, —OC(═O)—, and —C(═O)O— is bonded or a linking group obtained by combining one or more groups selected from the group consisting of —OC(═O)—, —C(═O)O—, —O—, and a linear alkylene group having 1 to 10 carbon atoms. Preferably, Sp¹ and Sp² are each a linear alkylene group that has 1 to 10 carbon atoms and has terminals to each of which —O— is bonded.

Q¹ and Q² each independently represent a hydrogen atom or a polymerizable group selected from the group consisting of the groups represented by formula Q-1 to formula Q-5 above, provided that one of Q¹ and Q² represents a polymerizable group.

The polymerizable group is preferably an acryloyl group (formula Q-1) or a methacryloyl group (formula Q-2).

In formula (I), m represents an integer of 3 to 12. m is preferably an integer of 3 to 9, more preferably an integer of 3 to 7, still more preferably an integer of 3 to 5.

The polymerizable compound represented by formula (I) preferably includes, as A, at least one optionally substituted phenylene group and at least one optionally substituted trans-1,4-cyclohexylene group. The polymerizable compound represented by formula (I) preferably includes, as A, 1 to 4 optionally substituted trans-1,4-cyclohexylene groups, more preferably 1 to 3 optionally substituted trans-1,4-cyclohexylene groups, still more preferably 2 or 3 optionally substituted trans-1,4-cyclohexylene groups. The polymerizable compound represented by formula (I) preferably includes, as A, one or more optionally substituted phenylene groups, more preferably 1 to 4 optionally substituted phenylene groups, still more preferably 1 to 3 optionally substituted phenylene groups, particularly preferably 2 or 3 optionally substituted phenylene groups.

In formula (I), when mc is a number obtained by dividing the number of trans-1,4-cyclohexylene groups represented by A by m, mc preferably satisfies 0.1<mc<0.9, more preferably 0.3<mc<0.8, still more preferably 0.5<mc<0.7. The liquid crystal composition may also include a polymerizable compound represented by formula (I) and satisfying 0.1<mc<0.3 in addition to a polymerizable compound represented by formula (I) and satisfying 0.5<mc<0.7.

Specific examples of the polymerizable compound represented by formula (I) include compounds described in paragraphs 0051 to 0058 in WO2016/047648A and compounds described in JP2013-112631A, JP2010-70543A, JP4725516B, WO2015/115390A, WO2015/147243A, WO2016/035873A, JP2015-163596A, and JP2016-53149A.

### Chiral Agent: Optically Active Compound

The chiral agent has a function of inducing a helical structure of a cholesteric liquid crystal phase. The chiral compound may be selected according to the purpose because the helical sense or helical pitch to be induced varies depending on the compound.

The chiral agent is not particularly limited, and known compounds can be used. Examples of the chiral agent include compounds described in Liquid Crystal Device Handbook (chapter 3, section 4-3, Chiral Agent for TN and STN, p. 199, edited by 142nd Committee of Japan Society for the Promotion of Science, 1989), JP2003-287623A, JP2002-302487A, JP2002-080478A, JP2002-080851A, JP2010-181852A, and JP2014-034581A.

Although chiral agents generally include asymmetric carbon atoms, axial asymmetric compounds or planar asymmetric compounds, which include no asymmetric carbon atoms, can also be used as chiral agents. Examples of axial asymmetric compounds or planar asymmetric compounds include binaphthyls, helicenes, paracyclophanes, and derivatives thereof.

The chiral agent may have a polymerizable group. When the chiral agent and the liquid crystal compound each have a polymerizable group, a polymer having a repeating unit derived from the polymerizable liquid crystal compound and a repeating unit derived from the chiral agent can be formed by the polymerization reaction between the polymerizable chiral agent and the polymerizable liquid crystal compound. In this case, the polymerizable group of the polymerizable chiral agent is preferably the same type of group as the polymerizable group of the polymerizable liquid crystal compound. Therefore, the polymerizable group of the chiral agent is also preferably an unsaturated polymerizable group, an epoxy group, or an aziridinyl group, more preferably an unsaturated polymerizable group, particularly preferably an ethylenically unsaturated polymerizable group.

The chiral agent may be a liquid crystal compound.

Preferred examples of the chiral agent include isosorbide derivatives, isomannide derivatives, and binaphthyl derivatives. Commercially available isosorbide derivatives such as LC756 manufactured by BASF may be used.

The content of the chiral agent in the liquid crystal composition is preferably 0.01 to 200 mol %, more preferably 1 to 30 mol %, relative to the amount of the polymerizable liquid crystal compound. The content of the chiral agent in the liquid crystal composition means the concentration (mass %) of the chiral agent relative to the total solids content of the composition.

### Polymerization Initiator

The liquid crystal composition preferably contains a polymerization initiator. In the case where polymerization reaction is caused to proceed through ultraviolet irradiation, the polymerization initiator used is preferably a photopolymerization initiator capable of initiating polymerization reaction through ultraviolet irradiation.

Examples of the photopolymerization initiator include α-carbonyl compounds (described in U.S. Pat. Nos. 2,367,661A and 2,367,670A), acyloin ethers (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimers and p-aminophenyl ketone (described in U.S. Pat. No. 3,549,367A), acridine and phenazine compounds (described in JP1985-105667A (JP-S60-105667A) and U.S. Pat. No. 4,239,850A), acylphosphine oxide compounds (JP1988-040799B (JP-S63-040799B), JP1993-029234B (JP-H5-029234B), JP1998-095788A (JP-H10-095788A), and JP1998-029997A (JP-H10-029997A), JP2001-233842A, JP2000-080068A, JP2006-342166A, JP2013-114249A, JP2014-137466A, JP4223071B, JP2010-262028A, and JP2014-500852A), oxime compounds (described in JP2000-066385A and JP4454067B), and oxadiazole compounds (described in U.S. Pat. No. 4,212,970A). For example, the description in paragraphs 0500 to 0547 of JP2012-208494A can also be taken into consideration.

The polymerization initiator is also preferably an acylphosphine oxide compound or an oxime compound.

The acylphosphine oxide compound may be, for example, a commercially available IRGACURE 819 (compound name: bis(2,4,6-trimethylbenzoyl)-phenylphosphine oxide) manufactured by BASF Japan. Examples of the oxime compound include commercially available products such as IRGACURE OXE01 (manufactured by BASF), IRGACURE OXE02 (manufactured by BASF), TR-PBG-304 (manufactured by Changzhou Tronly New Electronic Materials Co., Ltd.), and ADEKA ARKLS NCI-831 and ADEKA ARKLS NCI-930 (manufactured by ADEKA Corporation).

The polymerization initiators may be used alone or in combination of two or more.

The content of the photopolymerization initiator in the liquid crystal composition is preferably 0.1 to 20 mass %, more preferably 0.5 to 5 mass %, relative to the content of the polymerizable liquid crystal compound.

### Crosslinking Agent

The liquid crystal composition may optionally contain a crosslinking agent to improve the film hardness and durability after curing. Crosslinking agents that are curable by, for example, ultraviolet rays, heat, or moisture are suitable for use.

The crosslinking agent is not particularly limited and can be appropriately selected according to the purpose. Examples of the crosslinking agent include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris[3-(1-aziridinyl)propionate] and 4,4-bis(ethyleneiminocarbonylamino)diphenylmethane; isocyanate compounds such as hexamethylene diisocyanate and biuret-type isocyanate; polyoxazoline compounds having oxazoline side groups; and alkoxysilane compounds such as vinyltrimethoxysilane and N-(2-aminoethyl)3-aminopropyltrimethoxysilane. In addition, a known catalyst can be used according to the reactivity of the crosslinking agent. This can improve the productivity in addition to the film hardness and the durability. These may be used alone or in combination of two or more.

The content of the crosslinking agent is preferably 3 to 20 mass %, more preferably 5 to 15 mass %. When the content of the crosslinking agent is 3 mass % or more, the crosslink density can be improved. When the content of the crosslinking agent is 20 mass % or less, deterioration of the stability of the cholesteric liquid crystal layer can be prevented.

The term “(meth)acrylate” is used to mean “one or both of acrylate and methacrylate”.

### Alignment Controlling Agent

The liquid crystal composition may contain an alignment controlling agent which contributes to stably or rapidly providing a cholesteric liquid crystal layer having planar alignment. Examples of the alignment controlling agent include fluorine (meth)acrylate polymers described in paragraphs [0018] to [0043] of JP2007-272185A, compounds represented by formulae (I) to (IV) described in paragraphs [0031] to [0034] of JP2012-203237A, and compounds described in JP2013-113913A.

The alignment controlling agents may be used alone or in combination of two or more.

The amount of the alignment controlling agent in the liquid crystal composition is preferably 0.01 to 10 mass %, more preferably 0.01 to 5 mass %, particularly preferably 0.02 to 1 mass %, relative to the total mass of the polymerizable liquid crystal compound.

### Other Additives

The liquid crystal composition may further contain at least one selected from the group consisting of various additives such as surfactants for adjusting the surface tension of a coating to make the thickness uniform and polymerizable monomers. The liquid crystal composition may further optionally contain, for example, a polymerization inhibitor, an antioxidant, an ultraviolet absorber, a light stabilizer, a coloring material, and fine metal oxide particles to the degree that the optical performance is not degraded.

The cholesteric liquid crystal layer is formed, for example, as follows. First, a liquid crystal composition is prepared by dissolving a polymerizable liquid crystal compound, a polymerization initiator, an optionally added chiral agent, an optionally added surfactant, and the like in a solvent. The liquid crystal composition prepared is then applied onto a resin layer, an alignment film, the polarization conversion layer 16, a previously produced cholesteric liquid crystal layer, or the like, and dried to obtain a coating. Furthermore, this coating is irradiated with active rays to polymerize the liquid crystal composition (polymerizable liquid crystal compound), whereby a cholesteric liquid crystal layer whose cholesteric regularity is fixed can be formed.

A laminated film constituted by a plurality of cholesteric liquid crystal layers can be formed by repeating the above process for producing a cholesteric liquid crystal layer.

### Solvent

The solvent used for preparing the liquid crystal composition is not particularly limited. The solvent can be appropriately selected according to the purpose, and an organic solvent is preferably used.

The organic solvent is not particularly limited and can be appropriately selected according to the purpose. Examples include ketones, alkyl halides, amides, sulfoxides, heterocyclic compounds, hydrocarbons, esters, and ethers. These may be used alone or in combination of two or more. Of these, ketones are particularly preferred in view of environmental impact.

### Coating, Alignment, and Polymerization

The method of applying the liquid crystal composition to a support, an alignment film, a cholesteric liquid crystal layer to serve as an underlayer, and the like is not particularly limited, and can be appropriately selected according to the purpose. Examples of coating methods include wire bar coating, curtain coating, extrusion coating, direct gravure coating, reverse gravure coating, die coating, spin coating, dip coating, spray coating, and slide coating. Alternatively, a liquid crystal composition that has been applied onto another support may be transferred.

By heating the applied liquid crystal composition, liquid crystal molecules are aligned. The heating temperature is preferably 200° C. or lower, more preferably 130° C. or lower. This alignment treatment provides an optical thin film in which the polymerizable liquid crystal compound is twistedly aligned so as to have a helical axis in a direction substantially perpendicular to the film surface.

The aligned liquid crystal compound can be further polymerized to cure the liquid crystal composition. The polymerization may be thermal polymerization or photopolymerization that uses irradiation with light, and is preferably photopolymerization. The irradiation with light is preferably performed by using ultraviolet rays. The irradiation energy is preferably 20 mJ/cm² to 50 J/cm², more preferably 100 to 1,500 mJ/cm².

To promote the photopolymerization reaction, the irradiation with light may be performed under heating conditions or in a nitrogen atmosphere. The wavelength of ultraviolet rays applied is preferably 350 to 430 nm. The rate of polymerization reaction is preferably as high as possible from the viewpoint of stability. Specifically, the rate of polymerization reaction is preferably 70% or more, more preferably 80% or more. The rate of polymerization reaction can be determined by measuring the consumption rate of polymerizable functional groups by using an infrared absorption spectrum.

### Linearly Polarized Light Reflection Layer

In the projection image displaying member 10, the selective reflection layer may be a linearly polarized light reflection layer.

The linearly polarized light reflection layer may be, for example, a polarizing plate formed of a laminate of thin films having different refractive index anisotropies. Such a polarizing plate has a high visible light transmittance similarly to the cholesteric liquid crystal layer and can reflect, at a wavelength with high luminosity, projection light obliquely incident on the polarizing plate during the operation of a HUD.

The polarizing plate formed of a laminate of thin films having different refractive index anisotropies may be, for example, a polarizing plate described in JP1997-506837A (JP-H9-506837A). Specifically, when processing is performed under conditions selected to achieve refractive index relations, the polarizing plate can be formed using various materials. In general, one of first materials needs to have, in a selected direction, a refractive index different from that of a second material. This difference in refractive index can be achieved by various methods including stretching during or after film formation, extrusion molding, and coating. In addition, the two materials preferably have similar rheological properties (e.g., melt viscosity) so that they can be coextruded.

The polarizing plate formed of a laminate of thin films having different refractive index anisotropies may be a commercially available polarizing plate. The commercially available polarizing plate may be a laminate of a reflective polarizing plate and a temporary support. Examples of commercially available polarizing plates include commercially available optical films marketed as DBEF (registered trademark) (manufactured by 3M) and APF (Advanced Polarizing Film (manufactured by 3M)).

The thickness of the linearly polarized light reflection layer is preferably 2.0 to 50 μm, more preferably 8.0 to 30 μm.

### Polarization Conversion Layer

The polarization conversion layer 16 converts linearly polarized light into circularly polarized light and converts circularly polarized light into linearly polarized light. Alternatively, the polarization conversion layer 16 changes the polarization direction of linearly polarized light.

In the projection image displaying member 10 of the present invention, the polarization conversion layer 16 is located closer to the side on which projection light is incident than the selective reflection layer 14 is.

In the projection image displaying member of the present invention, the polarization conversion layer 16 is not an essential constituent member. That is, the projection image displaying member of the present invention may be composed only of, for example, the selective reflection layer 14 and the transparent substrate 12.

However, the presence of the polarization conversion layer 16 in the projection image displaying member can improve the display brightness of projection light in the case where the projection image displaying member is used in a HUD. Therefore, the projection image displaying member of the present invention preferably has the polarization conversion layer 16 as illustrated in the figure.

The polarization conversion layer 16 is, for example, a phase difference layer. In particular, a λ/4 layer (λ/4 phase difference layer), whose phase difference in the plane direction is λ/4, is preferred. Therefore, the in-plane retardation Re of the phase difference layer, for example, at a wavelength of 550 nm is preferably 100 to 450 nm, more preferably 120 to 200 nm or 300 to 400 nm.

The phase difference layer serving as the polarization conversion layer 16 may also be a λ/2 layer (λ/2 phase difference layer), a 3λ/4 layer (3λ/4 phase difference layer), or the like.

As will be described later, the phase difference layer serving as the polarization conversion layer 16 is disposed with the position of the slow axis set, according to the rotational direction of circularly polarized light that the cholesteric liquid crystal layer reflects, such that p-polarized light is converted into circularly polarized light having a rotational direction reflected by the cholesteric liquid crystal layer.

The phase difference layer is not limited, and various known phase difference layers can be used as long as they can convert linearly polarized light into circularly polarized light.

Examples of the phase difference layer include stretched polycarbonate films, stretched norbornene polymer films, transparent films in which inorganic particles having birefringence, such as strontium carbonate, are aligned, thin films obtained by oblique vapor deposition of an inorganic dielectric on a support, films obtained by uniaxially aligning a polymerizable liquid crystal compound and fixing the alignment, and films obtained by uniaxially aligning a liquid crystal compound and fixing the alignment.

Among them, films obtained by uniaxially aligning a polymerizable liquid crystal compound and fixing the alignment are suitable as the phase difference layer.

Such a phase difference layer can be formed, for example, by applying a liquid crystal composition including a polymerizable liquid crystal compound onto a surface of a temporary support or an alignment film, subjecting the polymerizable liquid crystal compound in a liquid crystalline state in the liquid crystal composition to nematic alignment, and then fixing the alignment by performing curing.

The formation of a phase difference layer in this case can be performed in the same manner as the formation of the cholesteric liquid crystal layer described above, except that no chiral agents are added to the liquid crystal composition. In the nematic alignment after the application of the liquid crystal composition, the heating temperature is preferably 50° C. to 120° C., more preferably 60° C. to 100° C.

The phase difference layer may be a layer obtained by applying a composition including a high-molecular-weight liquid crystal compound onto a surface of a temporary support, an alignment film, or the like, forming nematic alignment in a liquid crystalline state, and then fixing the alignment by performing cooling.

The thickness of the phase difference layer is not limited, and is preferably 0.2 to 300 μm, more preferably 0.5 to 150 μm, still more preferably 1.0 to 80 μm. The thickness of the phase difference layer formed using the liquid crystal composition is not particularly limited, and is preferably 0.2 to 10 μm, more preferably 0.5 to 5.0 μm, still more preferably 0.7 to 2.0 μm.

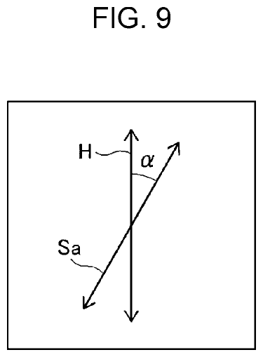

As illustrated in FIG. 9, the phase difference layer has, for example, a slow axis Sa set at an angle α with respect to an axis H of the phase difference layer in a certain direction. The direction of the slow axis Sa can be set, for example, by performing rubbing treatment on the alignment film underlying the phase difference layer.

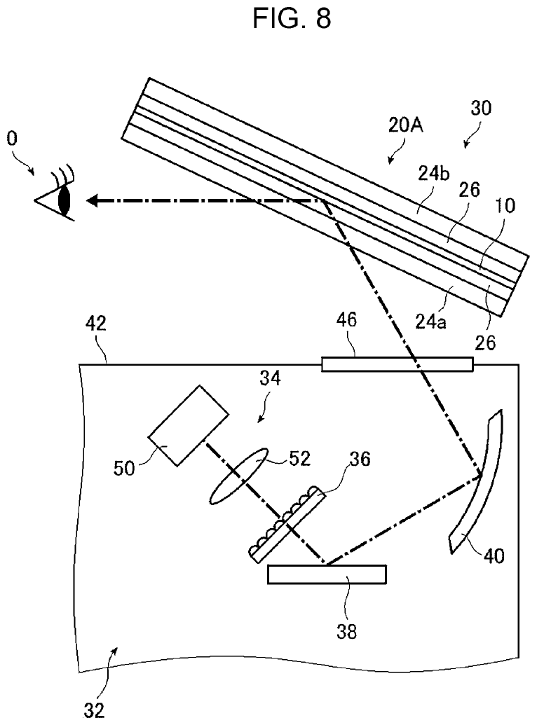

The direction of the slow axis Sa of the phase difference layer is preferably determined according to the direction in which projection light for projection image display is incident in the case where the projection image displaying member 10 is used in a HUD (see FIG. 8) and the helical sense of the cholesteric liquid crystal layers constituting the selective reflection layer 14.

As will be described later, in a HUD using the projection image displaying member 10 of the present invention, a projector emits p-polarized projection light, and the projection image displaying member 10 reflects p-polarized light to display a screen image.

Specifically, in the projection image displaying member 10, first, the phase difference layer converts incident p-polarized projection light into circularly polarized light. Subsequently, the selective reflection layer 14 (cholesteric liquid crystal layers) selectively reflects the circularly polarized light, which re-enters the phase difference layer. Furthermore, the phase difference layer converts the circularly polarized light into p-polarized light. Thus, the projection image displaying member 10 reflects incident p-polarized projection light as p-polarized light.

Therefore, the direction of the slow axis Sa of the phase difference layer is set, according to the sense of circularly polarized light selectively reflected by the selective reflection layer 14 (cholesteric liquid crystal layers), such that incident p-polarized light is converted into circularly polarized light having a rotational direction reflected by the selective reflection layer 14. That is, when the selective reflection layer 14 selectively reflects right-handed circularly polarized light, the direction of the slow axis Sa of the phase difference layer is set such that incident p-polarized light is converted into right-handed circularly polarized light. By contrast, when the selective reflection layer 14 selectively reflects left-handed circularly polarized light, the direction of the slow axis Sa of the phase difference layer is set with a reverse inclination such that incident p-polarized light is converted into left-handed circularly polarized light.

In the setting of the slow axis of the phase difference layer, for example, the direction of the slow axis Sa of the phase difference layer may be set assuming that the axis H shown in FIG. 9 is the vertical direction in the case where the projection image displaying member is mounted in a windshield glass and used as a HUD.

In the projection image displaying member 10 of the present invention, the polarization conversion layer 16 is not limited to the phase difference layer. The polarization conversion layer 16 may also be an optical rotation layer (twist layer) that is formed by fixing a helical alignment structure of a liquid crystal compound twistedly aligned along a helical axis extending in the thickness direction and that causes the polarization direction of linearly polarized light (p-polarized light) to rotate. That is, the polarization conversion layer 16 may be an optical rotation layer (optical rotation film) that twistedly aligns a liquid crystal compound.

The optical rotation layer serving as the polarization conversion layer 16 preferably, but not necessarily, satisfies at least one of (i) or (ii):

$$\begin{matrix}0.2 \leq x \leq 1.5 & ( i ) \\ 1.0 \leq y \leq 5.0 & ( ii )\end{matrix}$$

where x is a pitch number of the helical alignment structure, and y is a thickness (unit: μm) of the optical rotation layer. In particular, the optical rotation layer more preferably satisfies both inequality (i) and inequality (ii).

The helical pitch is as defined for the cholesteric liquid crystal layer described above.

The helical alignment structure of the optical rotation layer with a pitch number x of 0.2 or more is preferred in that, for example, linearly polarized light can be sufficiently rotated. The helical alignment structure of the optical rotation layer with a pitch number x of 1.5 or less is preferred in that, for example, unnecessary rotation of linearly polarized light can be prevented.

The optical rotation layer having a thickness of 1.0 μm or more is preferred in that, for example, linearly polarized light can be sufficiently rotated. The optical rotation layer having a thickness of 5.0 μm or less is preferred in that, for example, the projection image displaying member 10 can be prevented from becoming unnecessarily thick.

The pitch number x of the helical alignment structure of the optical rotation layer serving as the polarization conversion layer 16 is more preferably 0.25 to 1.3, still more preferably 0.3 to 1.0.

The thickness of the optical rotation layer serving as the polarization conversion layer 16 is more preferably 1.1 to 4.5 μm, still more preferably 1.2 to 4.0 μm.

Such an optical rotation layer may be formed in the same manner as the cholesteric liquid crystal layer described above so as to satisfy the thickness and the helical pitch number described above.

### Transparent Substrate

The projection image displaying member 10 of the present invention has the transparent substrate 12.

The transparent substrate 12 has an in-plane retardation Re of 5000 nm or more.

The transparent substrate 12 has a visible light transmittance of 80% or more. The visible light transmittance of the transparent substrate 12 is preferably 85% or more, more preferably 87% or more, still more preferably 90% or more.

As described above, in the projection image displaying member 10 of the present invention, the selective reflection layer 14 is located closer to the side on which projection light is incident than the transparent substrate 12 is.

Therefore, when the projection image displaying member 10 is mounted in a windshield glass and used as a HUD, the selective reflection layer 14 is on the vehicle interior side (inner surface side), which is the side on which projection light is incident, and the transparent substrate 12 is on the vehicle exterior side (outer surface side). That is, in the projection image displaying member 10, external light first passes through the transparent substrate 12 to enter the vehicle.

Due to the configuration in which this transparent substrate 12 is disposed on the opposite side of the selective reflection layer 14 from the side on which projection light is incident, that is, the side on which external light is incident, the projection image displaying member 10 of the present invention improves the polarizing sunglasses suitability of the HUD.

The HUD of the present invention using the projection image displaying member 10 of the present invention (the windshield glass of the present invention) displays a projection image in a manner that p-polarized projection light is allowed to be incident on the windshield glass, and the projection image displaying member 10 incorporated in the windshield glass reflects p-polarized light. Specifically, in the projection image displaying member 10, when the polarization conversion layer 16 is a phase difference layer, the phase difference layer (the polarization conversion layer 16) converts p-polarized light into circularly polarized light having a predetermined rotational direction, the selective reflection layer 14 reflects the circularly polarized light, and the phase difference layer reconverts the reflected circularly polarized light into p-polarized light. In this manner, the incident p-polarized light is reflected.

When p-polarized light is obliquely incident on glass, reflection by the glass is very little. In the HUD of the present invention, p-polarized light is projected, and the projection image displaying member 10 reflects the p-polarized light, whereby a double image due to light reflected by the inner surface and the outer surface of the windshield glass can be eliminated. Therefore, the windshield glass need not be wedge-shaped.

In addition, the projection image displaying member 10 having the polarization conversion layer 16 can reflect incident p-polarized light at a high reflectivity without loss, and thus the brightness of an image projected by the HUD can also be improved.

On the other hand, a so-called glare component entering a vehicle or the like from outside a windshield glass, such as reflected light from a puddle, reflected light from a windshield of an oncoming vehicle, or reflected light from a hood, is mostly s-polarized. Thus, polarizing sunglasses are configured to block s-polarized light components.

Therefore, in the case of a typical HUD that projects s-polarized projection light, a projection image cannot be observed when a driver wears polarizing sunglasses.

By contrast, the HUD using the projection image displaying member 10 of the present invention projects a p-polarized image. Thus, according to the present invention, a projection image of the HUD can be properly observed even when a driver wears polarizing sunglasses, unlike a HUD that projects s-polarized light.

Here, when polarized light of an unreflected component is incident on and transmitted through a reflection layer that selectively reflects predetermined circularly polarized light, such as a reflection layer using a cholesteric layer, the state of polarization changes.

As described above, a glare component entering from outside a windshield glass is mainly s-polarized. Therefore, s-polarized light that has been transmitted through a reflection layer that selectively reflects circularly polarized light corresponding to p-polarized light ideally becomes circularly polarized light having a rotational direction corresponding to s-polarized light. This circularly polarized light is then converted again into s-polarized light by a phase difference layer. Thus, s-polarized light, which is the glare component entering from outside the windshield glass, can be blocked by using polarizing sunglasses.

However, s-polarized light incident on the windshield glass from outside is incident on the reflection layer (reflection film, half mirror) of the windshield glass not only in the normal direction but also at various angles. Thus, in the case of a conventional HUD that projects p-polarized light by using a phase difference layer and a circularly polarized light reflection layer as disclosed in WO2016/056617A or JP2017-187685A, s-polarized light that has entered from outside and been transmitted through the reflection layer becomes elliptically polarized light instead of circularly polarized light.

When such elliptically polarized light is transmitted through the phase difference layer, the transmitted light contains not only s-polarized light components but also p-polarized light components. Since p-polarized light cannot be blocked by polarizing sunglasses, it is transmitted through the polarizing sunglasses.

Thus, in the case of a conventional HUD that projects p-polarized light, the function of polarizing sunglasses to reduce the glare of the above-described reflected light composed mainly of s-polarized light is impaired, and the glare of p-polarized light is transmitted through the polarizing sunglasses, thus interfering with driving. That is, conventional HUDs that project p-polarized light and use a half-mirror film using a phase difference layer and a circularly polarized light reflection layer as disclosed in WO2016/056617A and JP2017-187685A have low polarizing sunglasses suitability.

By contrast, the projection image displaying member 10 of the present invention has the transparent substrate 12 having an in-plane retardation Re of 5000 nm or more on the opposite side of the selective reflection layer 14 from the side on which projection light is incident, that is, the external light incident side of the selective reflection layer 14. That is, reflected light incident from outside the windshield and composed mainly of s-polarized light that causes glare is transmitted through the transparent substrate 12 and then transmitted through the selective reflection layer 14 and the polarization conversion layer 16 to reach the interior of the vehicle.

With this configuration, the projection image displaying member 10 of the present invention improves the polarizing sunglasses suitability of a HUD that projects p-polarized light.

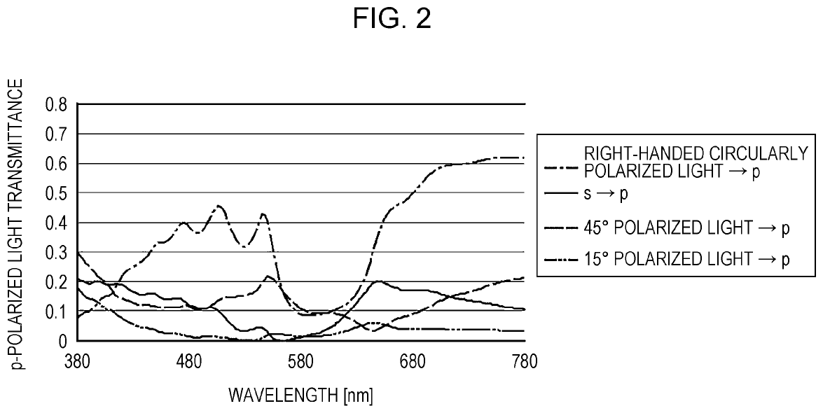

When light is incident on a half-mirror film having a reflection layer that selectively reflects predetermined circularly polarized light, such as a reflection layer using a cholesteric layer, and a phase difference layer (polarization conversion layer), from the reflection layer side, the ratio of conversion into p-polarized light varies depending on the polarization of incident light as shown in FIG. 2. Specifically, the ratio of conversion of circularly polarized light into p-polarized light is the highest, and the ratio of conversion of linearly polarized light polarized at an angle of 15° with respect to s-polarized light into p-polarized light is low.

That is, in this half-mirror film, the proportion of p-polarized light in transmitted light varies depending on the polarization direction of linearly polarized light incident from the reflection layer side.

By contrast, when s-polarized light is incident on the transparent substrate 12 having an in-plane retardation Re of 5000 nm or more, depolarization occurs, and the s-polarized light is converted into various types of polarized light such as left-handed circularly polarized light, right-handed circularly polarized light, and linearly polarized light with different polarization directions.

Here, in the transparent substrate 12, the ratio of polarized light converted as a result of transmission varies depending on the angle formed by the polarization direction of incident linearly polarized light and the slow axis of the transparent substrate 12.

Therefore, by disposing the transparent substrate 12 having a high in-plane retardation Re on the external light incident side of the half-mirror film having the selective reflection layer 14 and the polarization conversion layer 16 and adjusting the angle formed by incident s-polarized light and the slow axis of the transparent substrate 12 such that linearly polarized light incident on the selective reflection layer 14 is linearly polarized light that is converted into p-polarized light at a low ratio, the ratio of conversion of s-polarized light that has entered as external light into p-polarized light can be reduced.

To be precise, the angle formed by incident s-polarized light and the slow axis of the transparent substrate 12 is the angle formed by the plane of oscillation of s-polarized light (the oscillation direction of s-polarized light) and the slow axis of the transparent substrate 12.

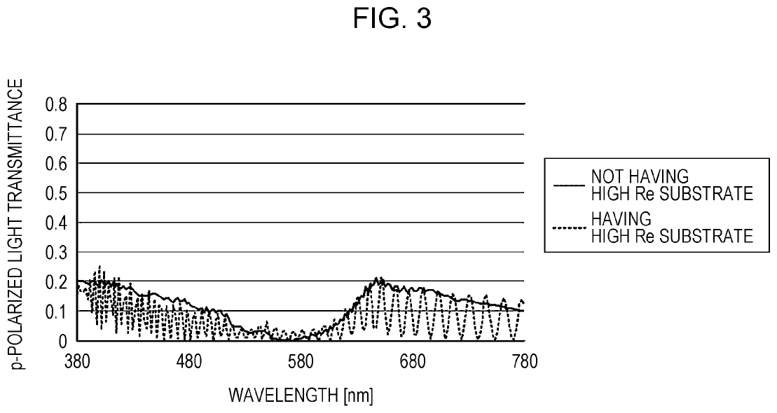

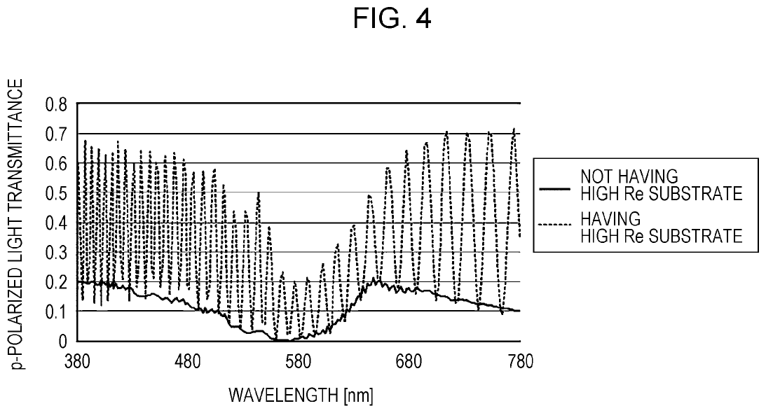

FIG. 3 and FIG. 4 each show p-polarized light reflectivities measured when s-polarized light is allowed to be incident on half-mirror films each having a λ/4 layer and a selective reflection layer constituted by a cholesteric liquid crystal layer from the cholesteric liquid crystal layer side, one of the half-mirror films having a transparent substrate on the selective reflection layer side and the other not.

FIG. 3 is an example where the angle formed by the s-polarized light and the slow axis of the transparent substrate is 15°. FIG. 4 is an example where the angle formed by the polarization direction of the s-polarized light and the slow axis of the transparent substrate is 60°.

As shown in FIG. 3, when a half-mirror film having a λ/4 layer and a selective reflection layer constituted by a cholesteric liquid crystal layer is provided, on the selective reflection layer side, with a transparent substrate with its slow axis inclined at 30° with respect to s-polarized light, the proportion of p-polarized light in transmitted light can be significantly reduced.

Therefore, according to the projection image displaying member 10 of the present invention (the windshield glass of the present invention and the HUD of the present invention) having the transparent substrate 12 having an in-plane retardation Re of 5000 nm or more, projection of p-polarized light enables observation of a HUD projection image with polarizing sunglasses on and eliminates the need for a wedge-shaped windshield glass, and can also suppress conversion of s-polarized light incident as external light into p-polarized light, thus improving the polarizing sunglasses suitability to block the glare of external light interfering with driving.

In the projection image displaying member 10 of the present invention, the angle formed by the slow axis of the transparent substrate 12 and s-polarized light is not limited.

That is, the angle formed by the slow axis of the transparent substrate 12 and s-polarized light at which the ratio of conversion of s-polarized light incident as external light into p-polarized light can be reduced varies depending on the polarization conversion layer 16. For example, when a phase difference layer is used as the polarization conversion layer 16, the angle formed by the slow axis of the transparent substrate 12 and s-polarized light at which the ratio of conversion of s-polarized light incident as external light into p-polarized light can be reduced varies whether the phase difference layer is a λ/4 layer, a λ/2 layer, or a 3λ/4 layer.

Therefore, the angle formed by the slow axis of the transparent substrate 12 and s-polarized light may be appropriately set according to the polarization conversion layer 16 used.

For example, when the polarization conversion layer 16 is a λ/4 layer, the angle formed by the slow axis of the transparent substrate 12 and s-polarized light is preferably 10° to 30°, more preferably 15° to 25°.

In general, s-polarized light of external light incident on vehicles and the like is horizontal linearly polarized light. The horizontal linearly polarized light is linearly polarized light whose oscillation plane (oscillation direction) is horizontal.

Therefore, in the context of the windshield glass of the present invention, s-polarized light is replaced with the horizontal direction, and the angle formed by the horizontal direction and the slow axis of the transparent substrate 12 of the projection image displaying member 10 is used. That is, in the windshield glass of the present invention, for example, when the polarization conversion layer 16 is a λ/4 layer, the angle formed by the slow axis of the transparent substrate 12 and the horizontal direction is preferably 10° to 30°.

In this regard, the same applies to the HUD of the present invention using the windshield glass of the present invention, which will be described later.

The material for forming the transparent substrate 12 is not limited, and various materials that provide the above-described visible light transmittance and the transparent substrate 12 having an in-plane retardation Re of 5000 nm or more can be used.

Examples include polyester resins, polyolefin resins, (meth)acrylic resins, polyurethane resins, polyether sulfone resins, polycarbonate resins, polysulfone resins, polyether resins, polyether ketone resins, (meth)acrylonitrile resins, and cycloolefin resins. Among them, polyester resins are preferred, and in particular, polyethylene terephthalate (PET) and polyethylene naphthalate (PEN) are more preferred.

The transparent substrate 12, when made of, for example, polyester such as PET, can be produced in the following manner. First, polyester as a material is melted and extrusion-molded into sheet form. The molded unstretched polyester is then heated to a temperature equal to or higher than its glass transition temperature and stretched in the cross direction using a tenter or the like. Thereafter, heat treatment is performed, whereby the transparent substrate 12 can be obtained.

By controlling the stretching ratio and the stretching temperature in this process, the in-plane retardation Re of the transparent substrate 12 can be controlled. In general, the in-plane retardation Re increases as the stretching ratio increases, and the in-plane retardation Re increases as the stretching temperature decreases.

The thickness of the transparent substrate 12 is also not limited. That is, the thickness of the transparent substrate 12 may be appropriately set to a thickness that provides the desired in-plane retardation Re according to the stretching ratio, the stretching temperature, and the formation material.

The thickness of the transparent substrate 12 is preferably 10 to 200 μm, more preferably 20 to 150 μm, still more preferably 40 to 100 μm.

### Alignment Film

The projection image displaying member 10 may have an alignment film as an underlayer to which the liquid crystal composition is applied when the selective reflection layer 14 (cholesteric liquid crystal layers) and/or the polarization conversion layer 16 is formed.

The alignment film can be provided by means of, for example, rubbing treatment of a layer formed of an organic compound such as a polymer (e.g., a resin such as polyimide, polyvinyl alcohol, polyester, polyarylate, polyamide-imide, polyetherimide, polyamide, or modified polyamide), oblique deposition of an inorganic compound, formation of a layer having microgrooves, or accumulation of an organic compound (e.g., co-tricosanoic acid, dioctadecylmethylammonium chloride, or methyl stearate) using the Langmuir-Blodgett technique (LB film). Furthermore, an alignment film whose alignment function is activated by application of an electric field, application of a magnetic field, or irradiation with light may be used.

In particular, for example, an alignment film obtained by performing rubbing treatment on a polymer layer is preferred. For the rubbing treatment, a known method can be used. For example, the rubbing treatment can be performed by rubbing a surface of a polymer layer with paper or cloth in a certain direction.

The liquid crystal composition may be applied onto a surface of a resin layer described later subjected to the rubbing treatment without providing an alignment film. That is, the resin layer may serve as an alignment film.

The thickness of the alignment film is not limited, and is preferably 0.01 to 5.0 μm, more preferably 0.05 to 2.0 μm.

When the projection image displaying member having the selective reflection layer and the like is produced using a temporary support, the alignment layer may be peeled off together with the temporary support. That is, the alignment film may be present only during the production of the projection image displaying member and need not be a layer constituting the projection image displaying member when the projection image displaying member has been completed.

### Resin Layer

The projection image displaying member 10 may have a resin layer on the surface of the polarization conversion layer 16. The surface of the polarization conversion layer 16 refers to a surface of the polarization conversion layer 16 facing away from the selective reflection layer 14.

The presence of a resin layer on the surface of the polarization conversion layer 16 is preferred in that, for example, damage to the polarization conversion layer 16 can be prevented.

The resin layer preferably has a high visible light transmittance.

The visible light transmittance of the resin layer is preferably 80% or more, more preferably 85% or more, still more preferably 90% or more.

The resin layer having a visible light transmittance of 80% or more is preferred in that, for example, a high-brightness projection image can be projected, and a high-brightness projection image that suffers little loss when reflected can be projected.

The in-plane retardation Re of the resin layer is not limited, but is preferably small.

The in-plane retardation Re of the resin layer is preferably 10 nm or less, more preferably 5 nm or less, still more preferably 2 nm or less.

The resin layer having an in-plane retardation Re of 10 nm or less is preferred in that, for example, loss of polarization of projection light due to the resin layer can be prevented, and less interference occurs when linearly polarized light is incident.

The thickness of the resin layer is not limited and may be appropriately set to a thickness that provides necessary performance according to the purpose of forming the resin layer and the material for forming the resin layer.

The thickness of the resin layer is preferably 5 to 1000 μm, more preferably 20 to 400 μm, still more preferably 40 to 100 μm.

The resin layer having a thickness of 5 μm or more is preferred in that, for example, the effect of forming the resin layer is suitably produced, and a certain degree of stiffness can be ensured to facilitate the positioning of the film at the time of transfer.

The resin layer having a thickness of 1000 μm or less is preferred in that, for example, the projection image displaying member 10 can be prevented from becoming unnecessarily thick, and the resin layer is readily transferred when a reflection member has a curvature.

The material for forming the resin layer is not limited, and various resin materials that preferably satisfy the conditions described above can be used.

Examples include PET, TAC (triacetylcellulose), PC (polycarbonate), COP (cycloolefin polymers), and PMMA (polymethyl methacrylate).

Instead of the resin layer, a glass plate may be provided on the surface of the polarization conversion layer 16.

The projection image displaying member 10 having such a configuration can be produced by various methods.

For example, a film to serve as the alignment film is formed on a surface of a resin film or the like to serve as the resin layer, and the alignment film is formed by performing, for example, rubbing treatment. Subsequently, the polarization conversion layer 16 is formed on the alignment film, and the selective reflection layer 14 such as a cholesteric liquid crystal layer is formed on the surface of the polarization conversion layer 16. In general, when a liquid crystal layer is laminated, the alignment of the liquid crystal compound follows the alignment state of an underlying liquid crystal layer.

The laminate constituted by the resin layer (alignment film), the polarization conversion layer 16, and the selective reflection layer 14 is then bonded to the transparent substrate 12 using the adhesive layer 18 such as an OCA with the selective reflection layer 14 facing the transparent substrate 12, thereby completing the projection image displaying member.

### Hard Coat Layer

The projection image displaying member 10 may optionally have a hard coat layer on the polarization conversion layer 16 or the resin layer (the side opposite the selective reflection layer 14) to improve scratch resistance.

### Hard Coat-Forming Composition

The hard coat layer is preferably formed using a hard coat layer forming composition.

The hard coat layer-forming composition preferably includes a compound having three or more ethylenically unsaturated double bond groups in its molecule.

Examples of ethylenically unsaturated double bond groups include polymerizable functional groups such as a (meth)acryloyl group, a vinyl group, a styryl group, and an allyl group. Among them, a (meth)acryloyl group and —C(O)OCH═CH₂ are preferred, and a (meth)acryloyl group is more preferred. When an ethylenically unsaturated double bond group is contained, high hardness can be maintained, and moist-heat resistance can be provided. Furthermore, when three or more ethylenically unsaturated double bond groups are contained in the molecule, higher hardness can be exhibited.

Examples of the compound having three or more ethylenically unsaturated double bond groups in its molecule include esters of polyhydric alcohols and (meth)acrylic acids, vinyl benzene and derivatives thereof, vinyl sulfone, and (meth)acrylamide. In particular, compounds having three or more (meth)acryloyl groups are preferred from the viewpoint of hardness, and examples include acrylate compounds that form cured products with high hardness and are widely used in this industrial field. Examples of such compounds include esters of polyhydric alcohols and (meth)acrylic acids. Examples of esters of polyhydric alcohols and (meth)acrylic acids include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl) isocyanurate.

Specific examples of polyfunctional acrylate compounds having three or more (meth)acryloyl groups include esters of polyols and (meth)acrylic acids, such as KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60, and KAYARAD GPO-303 manufactured by Nippon Kayaku Co., Ltd. and V #400 and V #36095D manufactured by Osaka Organic Chemical Industry Ltd.

For example, tri- or higher functional urethane acrylate compounds such as SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, SHIKOH UV-2250EA, and SHIKOH UV-2750B (manufactured by Nippon Synthetic Chemical Industry Co., Ltd.), UL-503LN (manufactured by Kyoeisha Chemical Co., Ltd.), UNIDIC 17-806, UNIDIC 17-813, UNIDIC V-4030, and UNIDIC V-4000BA (manufactured by DIC Corporation), EB-1290K, EB-220, EB-5129, EB-1830, and EB-4358 (manufactured by Daicel UCB Co., Ltd.), HIGH-COAP AU-2010 and HIGH-COAP AU-2020 (manufactured by Tokushiki Co., Ltd.), ARONIX M-1960 (manufactured by Toagosei Co., Ltd.), and Art Resin UN-3320HA, Art Resin UN-3320HC, Art Resin UN-3320HS, Art Resin UN-904, and Art Resin HDP-4T; and tri- or higher functional polyester compounds such as ARONIX M-8100, M-8030, and M-9050 (manufactured by Toagosei Co., Ltd.) and KBM-8307 (manufactured by Daicel-Cytec Co., Ltd.) are also suitable for use.

The compound having three or more ethylenically unsaturated double bond groups in its molecule may be composed of a single compound or a plurality of compounds combined together.

### Method of Forming Hard Coat Layer

The hard coat layer can be formed by applying the hard coat layer-forming composition described above to the surface of the resin layer and performing drying and curing.

### Coating Method for Hard Coat Layer

The hard coat layer can be formed by the following coating methods, but these methods are non-limiting examples. Known methods such as dip coating, air knife coating, curtain coating, roller coating, wire bar coating, gravure coating, slide coating, extrusion coating (die coating) (see JP2003-164788A), and microgravure coating are used. Among them, microgravure coating and die coating are preferred.

### Conditions for Drying and Curing Hard Coat Layer

Preferred examples of drying and curing methods in the case where a layer such as a hard coat layer is formed by coating in the present invention will be described below.

In the present invention, performing curing by combination of irradiation with ionizing radiation and heat treatment before, simultaneous with, or after the irradiation is effective.

Several non-limiting examples of production process patterns are shown below. In the following examples, “-” means that heat treatment is not performed.

Before irradiation→simultaneous with irradiation→after irradiation

(1) Heat treatment→ionizing radiation curing→-
(2) Heat treatment→ionizing radiation curing heat treatment
(3) -→ionizing radiation curing→heat treatment

In addition, a process in which heat treatment is performed simultaneously with ionizing radiation curing is also preferred.

In the present invention, when a hard coat layer is formed, it is preferable to perform heat treatment in combination with irradiation with ionizing radiation, as described above. The temperature of the heat treatment is not limited as long as constituent layers including the hard coat layer and a support for the hard coat layer are not damaged, but is preferably 25° C. to 150° C., more preferably 30° C. to 80° C.

The time of the heat treatment, although depending on, for example, the molecular weight, interaction with other components, and viscosity of components used, is about 15 seconds to 1 hour, preferably 20 seconds to 30 minutes, more preferably 30 seconds to 5 minutes.

Examples of the type of ionizing radiation include, but are not limited to, X-rays, electron beams, ultraviolet light, visible light, and infrared light, and ultraviolet light is widely used.

For example, in the case of an ultraviolet curable coating, it is preferable to cure layers by irradiation with ultraviolet light at a dose of 10 to 1000 mJ/cm² using an ultraviolet lamp. In the irradiation, ultraviolet light with this energy may be applied in one portion or divided portions. In particular, to reduce performance variation in the plane of the coating and further improve curling, ultraviolet light is preferably applied in two or more divided portions. For example, it is preferable to apply ultraviolet light at a low dose of 150 mJ/cm² or less at an initial stage and then apply ultraviolet light at a dose that is 50 mJ/cm² or more and higher than the dose at the initial stage.

### Windshield Glass

The windshield glass of the present invention is a windshield glass having the projection image displaying member of the present invention and used for a vehicle or the like. The windshield glass of the present invention is basically a known windshield glass (windscreen glass) except for having the projection image displaying member of the present invention.

The windshield glass of the present invention is used as a windscreen glass of common vehicles such as cars, trains, aircraft, ships, two-wheeled vehicles, and rides.

In the following description, the vehicle exterior and the vehicle interior refer to the aircraft exterior and the aircraft interior, respectively, in the case of an aircraft, and the ship exterior and the ship interior, respectively, in the case of a ship. In a HUD, projection light is projected from the vehicle interior side onto a windshield glass.

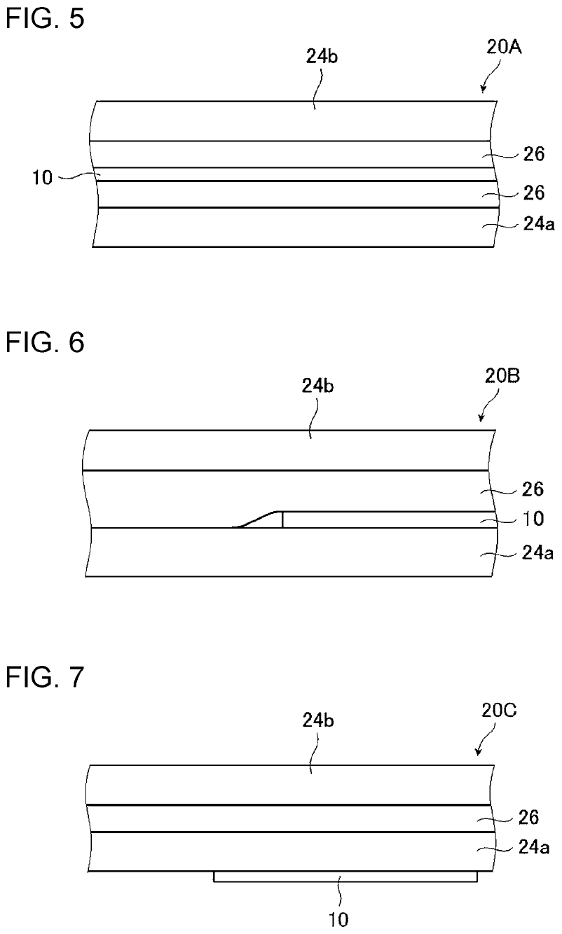

FIG. 5 schematically illustrates an example of the windshield glass of the present invention that uses the projection image displaying member 10 of the present invention.

A windshield glass 20A illustrated in FIG. 5 has a configuration in which the above-described projection image displaying member 10 of the present invention is sandwiched between intermediate films 26 and this laminate is sandwiched between a first glass plate 24a and a second glass plate 24b. In the windshield glass 20A of the present invention, the projection image displaying member 10 may be disposed throughout the entire windshield glass 20A or may be disposed in or on a part thereof. In this regard, the same applies to examples given later.

In the windshield glass 20A, the first glass plate 24a is on the vehicle interior side. Therefore, in the projection image displaying member 10, the selective reflection layer 14 and the transparent substrate 12 are disposed such that the selective reflection layer 14 (the polarization conversion layer 16) is located on the first glass plate 24a side and that the transparent substrate 12 is located on the second glass plate 24b side.

The first glass plate 24a and the second glass plate 24b may be glass plates commonly used for windshield glasses. For example, a glass plate having a visible light transmittance of 80% or less, for example, 73% or 76%, such as a green glass having high heat-shielding properties, may be used.

The first glass plate 24a and the second glass plate 24b may have any shape according to a vehicle or the like to which they are mounted. Therefore, the shape of the first glass plate 24a and the second glass plate 24b may be curved, flat, or a combination of curved and flat portions.

The thicknesses of the first glass plate 24a and the second glass plate 24b are not limited and may be appropriately set to thicknesses that provide sufficient strength according to, for example, the materials for forming the glass plates.

The thicknesses of the first glass plate 24a and the second glass plate 24b are preferably 0.5 to 5.0 mm, more preferably 1.0 to 3.0 mm, still more preferably 2.0 to 2.3 mm.

The materials and/or thicknesses of the first glass plate 24a and the second glass plate 24b may be the same or different.

The intermediate films 26 are also known intermediate films provided in laminated glass used as windshield glass. The intermediate films 26 bond together the first glass plate 24a and the second glass plate 24b and prevent the glass from breaking into the vehicle interior in the event of an accident.

The intermediate films 26 may be, for example, resin films containing a resin such as polyvinyl butyral (PVB), ethylene-vinyl acetate copolymer, or chlorine-containing resin. Each of these resins is preferably the principal component of the intermediate films. The principal component refers to a component that accounts for 50 mass % or more among components constituting a product.

Of the resins described above, polyvinyl butyral and ethylene-vinyl acetate copolymer are preferred, and polyvinyl butyral is more preferred. The resin is preferably a synthetic resin.

Polyvinyl butyral can be obtained by acetalizing polyvinyl alcohol with butyraldehyde. The lower limit of the degree of acetalization of the above polyvinyl butyral is preferably 40%, more preferably 60%, and the upper limit thereof is preferably 85%, more preferably 75%.

Polyvinyl alcohol is typically obtained by saponifying polyvinyl acetate, and a polyvinyl alcohol having a degree of saponification of 80 to 99.8 mol % is commonly used.

The lower limit of the degree of polymerization of the above polyvinyl alcohol is preferably 200, and the upper limit thereof is preferably 3000. When the degree of polymerization of the polyvinyl alcohol is 200 or more, the penetration resistance of a laminated glass to be obtained is less likely to decrease. When the degree of polymerization is 3000 or less, a resin film having good moldability is provided, and moreover, the stiffness of the resin film cannot be excessively high, thus providing good workability. The lower limit of the degree of polymerization is more preferably 500, and the upper limit thereof is more preferably 2000.

FIG. 6 illustrates another example of the windshield glass of the present invention.

In FIG. 6 to FIG. 8, since like members are frequently used in the windshield glasses, the like members are denoted by like reference signs. Therefore, in each example, the first glass plate 24a is on the vehicle interior side, and the second glass plate 24b is on the vehicle exterior side.

In the windshield glass 20A illustrated in FIG. 5, the projection image displaying member 10 is sandwiched between the intermediate films 26, and this laminate is sandwiched between the first glass plate 24a and the second glass plate 24b.

A windshield glass 20B illustrated in FIG. 6 has a configuration in which the projection image displaying member 10 is bonded to a single intermediate film 26, and the laminate of the projection image displaying member 10 and the single intermediate film 26 is sandwiched between the first glass plate 24a and the second glass plate 24b. In the case where the projection image displaying member 10 is smaller than an intermediate film (cut back), such a configuration is possible.

Also in this example, in the projection image displaying member 10, the selective reflection layer 14 is located on the first glass plate 24a side, and the transparent substrate 12 is located on the second glass plate 24b side.

Such a windshield glass may be produced in accordance with a known method.

For example, a laminate in which the projection image displaying member 10 is sandwiched between two intermediate films 26 or a laminate in which the projection image displaying member 10 is bonded to a single intermediate film 26 is provided.

Subsequently, this laminate is sandwiched between the first glass plate 24a and the second glass plate 24b.

The laminate in which the two glass plates are laminated is repeatedly subjected to heat treatment and pressure treatment several times, and finally subjected to heat treatment under pressurized conditions using an autoclave or the like, thereby producing a windshield glass. The pressure treatment is, for example, a treatment using rubber rollers.

FIG. 7 illustrates another example of the windshield glass of the present invention.

A windshield glass 20C illustrated in FIG. 7 has a configuration in which the projection image displaying member 10 is not disposed between the first glass plate 24a and the second glass plate 24b but bonded to the first glass plate 24a on the vehicle interior side. That is, the windshield glass 20C illustrated in FIG. 7 is a product obtained by bonding the projection image displaying member 10 of the present invention to the inside surface of a vehicle interior side glass (vehicle interior side surface) of a known windshield glass.

In the windshield glass 20C, external light is incident on the projection image displaying member 10 from the first glass plate 24a side. Projection light is incident from the vehicle interior side, as in the other examples.

Therefore, in the projection image displaying member 10 of the windshield glass 20C, the selective reflection layer 14 and the transparent substrate 12 are disposed such that the transparent substrate 12 is located on the first glass plate 24a side, and the selective reflection layer 14 is located farther away from the first glass plate 24a than the transparent substrate 12 is.

The bonding of the projection image displaying member 10 to the first glass plate 24a may be performed by a known method.

For example, the projection image displaying member 10 may be bonded to the first glass plate 24a by using the above-described adhesive layer 18 of the projection image displaying member 10. Here, the thickness of the adhesive layer is as described for the adhesive layer 18 above.

### HUD (Head-Up Display (System))

FIG. 8 schematically illustrates an example of the HUD of the present invention.

A HUD 30 illustrated in FIG. 8 has the windshield glass 20A of the present invention described above and a projector 32. The windshield glass 20B illustrated in FIG. 6 and the windshield glass 20C illustrated in FIG. 7 can also be used for the HUD illustrated in FIG. 8.

In the HUD 30 of the present invention, the projector 32 projects p-polarized projection light.

The projector 32 illustrated in FIG. 8 has a screen image forming unit 34, an intermediate image screen 36, a mirror 38, and a concave mirror 40.

In the HUD 30 illustrated in FIG. 8, projection light projected by the projector 32 is transmitted through a transmission window 46 provided in a dashboard 42, projected on and reflected by the windshield glass 20A, and observed by a driver O, as indicated by the chain line.

In the HUD illustrated in the figure, as in a known HUD, the driver O observes a virtual image of a screen image projected on the windshield glass 20A.

The HUD using the projection image displaying member of the present invention is not limited to a HUD (windshield HUD) that projects a projection image on the windshield glass 20A as illustrated in the figure.

That is, as the HUD using the present invention, various known HUDs that project projection images on various members, such as a HUD (combiner HUD) that projects a projection image on a so-called combiner, can be used. In this case, the combiner has the projection image displaying member of the present invention.

The screen image forming unit 34 has an LCD 50 (liquid crystal display) and a projection lens 52.

The LCD 50 and the projection lens 52 are respectively a known LCD and a known projection lens that are used in a HUD projector. The screen image forming unit 34 projects a screen image displayed by the LCD 50 onto the intermediate image screen 36 through the projection lens 52.

In the projector 32, the screen image is formed into a real image by the intermediate image screen 36, and the real image is reflected by the mirror 38 and the concave mirror 40 to travel along a predetermined optical path. As described above, this reflected light is transmitted through the transmission window 46 provided in the dashboard 42, projected onto the windshield glass 20A, and observed by the driver O (see the chain line).

The LCD 50 displays a p-polarized screen image (projection image).

When the LCD 50 does not display p-polarized projection light, for example, a polarizing plate that converts projection light from the LCD 50 into p-polarized light is provided midway along a projection light path extending from the LCD 50 to the concave mirror 40.

Alternatively, a polarizing plate that converts projection light from the LCD 50 into p-polarized light may be provided outside the projector 32, that is, midway along a projection light path extending from the concave mirror 40 to the windshield glass 20A. In this case, this polarizing plate is also regarded as an optical element constituting the projector 32.

The above also applies to various screen image forming means described later.

The polarizing plate may be, for example, a polarizing plate formed of a laminate of thin films having different refractive index anisotropies. The polarizing plate formed of a laminate of thin films having different refractive index anisotropies may be, for example, a polarizing plate described in JP1997-506837A (JP-H9-506837A). Specifically, when processing is performed under conditions selected to achieve refractive index relations, the polarizing plate can be formed using various materials.

In general, one of first materials needs to have, in a selected direction, a refractive index different from that of a second material. This difference in refractive index can be achieved by various methods including stretching during or after film formation, extrusion molding, and coating. In addition, the two materials preferably have similar rheological properties (e.g., melt viscosity) so that they can be coextruded.

The polarizing plate formed of a laminate of thin films having different refractive index anisotropies may be a commercially available polarizing plate. The commercially available polarizing plate may be a laminate of a reflective polarizing plate and a temporary support. Examples of commercially available polarizing plates include DBEF (manufactured by 3M) and APF (Advanced Polarizing Film (manufactured by 3M)).

The polarizing plate may also be a commonly used linearly polarizing plate, such as an absorptive polarizing plate containing an iodine compound or a reflective polarizing plate such as a wire grid.

In the projector constituting the HUD of the present invention, the screen image forming unit 34 is not limited to those using the LCD 50, and various known screen image forming means used in HUD projectors can be used.

For example, various known screen image forming means used in HUD projectors (imagers), such as vacuum fluorescent displays, LCOS (liquid crystal on silicon) using liquid crystals, organic electroluminescent (organic EL) displays, and DLP (digital light processing), which uses a DMD (digital micromirror device), can be used. When these screen image forming means are used, as in the case where the LCD 50 is used, a projection image is projected onto the intermediate image screen 36 through a projection lens.

As the screen image forming means of the screen image forming unit 34, screen image forming means using light beam scanning can also be used, which forms a projection image as follows: a light beam modulated according to a screen image to be formed is emitted from a light source, R light, G light, and B light are combined together as required, and the light beam is then converted into p-polarized light and two-dimensionally scanned with a light deflector.

The modulation of a light beam according to a screen image to be projected may be performed by direct modulation of the light source or by using an external light modulator.

Examples of the light source include LEDs (including light emitting diodes and organic light emitting diodes (OLEDs)), discharge tubes, and laser light sources.

Examples of two-dimensional light deflectors include galvano mirrors (galvanometer mirrors), combinations of galvano mirrors and polygon mirrors, and MEMS (micro electro mechanical systems). Among them, MEMS are suitable for use. The method of scanning is not limited, and known light beam scanning methods such as random scanning and raster scanning can be used. Among them, raster scanning is suitable.

Projection light emitted from the screen image forming unit 34 is then formed into a real image (visible image) by the intermediate image screen 36.

The intermediate image screen 36 is not limited, and various known intermediate image screens that form a projection image into a real image in a HUD projector can be used.

Examples of the intermediate image screen 36 include scattering films, microlens arrays, and rear-projection screens. For example, in the case where the intermediate image screen 36 is made of a plastic material, if the intermediate image screen 36 exhibits birefringence, the polarization plane and light intensity of polarized light incident on the intermediate image screen 36 are disturbed, and as a result, color unevenness or the like is likely to occur in a projection image. In this case, this color unevenness can be reduced by using a phase difference layer having a predetermined phase difference.

The intermediate image screen 36 preferably has a function of transmitting incident projection light while diverging the projection light. This is because the function enables enlarged display of a projection image.

One example of such an intermediate image screen is an intermediate image screen constituted by a microlens array. The microarray lens used in a HUD is described in, for example, JP2012-226303A, JP2010-145745A, and JP2007-523369A.

As described above, the projection light formed into a real image by the intermediate image screen 36 is reflected by the mirror 38 and the concave mirror 40 to travel along the predetermined optical path, transmitted through the transmission window 46 provided in the dashboard 42, projected onto the windshield glass 20A, and observed by the driver O (see the chain line).

The mirror 38 is a known mirror used to adjust the path of projection light in a projector. The mirror 38 may also be a so-called cold mirror that reflects visible light and transmits infrared light to thereby prevent constituent members of a projector from being heated by sunlight that has entered through a windshield glass.

On the other hand, the concave mirror 40 is a known concave mirror used in a HUD projector that enlarges and projects projection light.

In the illustrated the projector 32, the mirror 38 and the concave mirror 40 are used as members for changing the path of projection light, but the present invention is not limited to this configuration.

For example, the projector 32 may have only one of the mirror 38 and the concave mirror 40 or may have one or more other light reflection elements such as free-form surface mirrors in addition to or instead of the mirror 38 and/or the concave mirror 40.

That is, the projector constituting the HUD of the present invention may have any configuration in which various light reflection elements are used, as long as p-polarized projection light can be projected.

The p-polarized projection light projected by the projector 32, transmitted through the transmission window 46, and incident on the windshield glass 20A is transmitted through the first glass plate 24a and the intermediate film 26 and incident on the projection image displaying member 10.

For example, when the polarization conversion layer 16 is a λ/4 plate, the p-polarized projection light incident on the projection image displaying member 10 is converted into circularly polarized light having a rotational direction corresponding to p-polarized light by the polarization conversion layer 16. The converted circularly polarized projection light is reflected by the selective reflection layer 14. The circularly polarized projection light reflected by the selective reflection layer 14 is converted again into p-polarized light by the polarization conversion layer 16 (λ/4 plate), emitted as reflected light, and observed as a projection image by the driver O.

This projection light is p-polarized light. Therefore, even when the driver O wears polarizing sunglasses that block s-polarized light, the projection image can be properly observed.

On the other hand, external light incident on the outer surface of the windshield glass 20A, that is, the second glass plate 24b is transmitted through the second glass plate 24b and the intermediate film 26 and incident on the projection image displaying member 10 from the transparent substrate 12 side.

The s-polarized light incident on the projection image displaying member 10 and causing glare is first transmitted through the transparent substrate 12 and converted by the selective reflection layer 14 and the polarization conversion layer 16 (λ/4 plate) into light in which the proportion of polarization components converted into p-polarized light is small. This light is then transmitted through the selective reflection layer 14 and the polarization conversion layer 16 and enters the vehicle through the intermediate film 26 and the first glass plate 24a. Therefore, among the external light that has entered the vehicle, the glare component is mainly s-polarized light, which is blocked by polarizing sunglasses and does not interfere with driving.

While the projection image displaying member, the windshield, and the HUD (head-up display system) of the present invention have been described above in detail, it should be appreciated that the present invention is not limited to the foregoing examples, and various modifications and changes may be made without departing from the spirit of the invention.

### EXAMPLES

The present invention will now be described more specifically with reference to Examples of the present invention. Materials, reagents, amounts and percentages of substances, operations, and the like used in Examples, Comparative Examples, and Production Examples below can be appropriately changed without departing from the spirit of the present invention. Therefore, the scope of the present invention is not limited to Examples and Reference Examples below.

### Cholesteric Liquid Crystal Layer-Forming Compositions 1, 2, and 3

By mixing the following components, a cholesteric liquid crystal layer-forming composition 1 for forming a cholesteric liquid crystal layer having a selective reflection center wavelength of 480 nm at an incidence angle of 5°, a cholesteric liquid crystal layer-forming composition 2 for forming a cholesteric liquid crystal layer having a selective reflection center wavelength of 650 nm at an incidence angle of 5°, and a cholesteric liquid crystal layer-forming composition 3 for forming a cholesteric liquid crystal layer having a selective reflection center wavelength of 700 nm at an incidence angle of 5° were prepared.

Cholesteric liquid crystal layer-forming compositions 1, 2, and 3

| Mixture 1 | 100 | parts by mass |
|---|---|---|
| Alignment controlling agent 1 (fluorine-based horizontal alignment agent 1) | 0.05 | parts by mass |
| Alignment controlling agent 2 (fluorine-based horizontal alignment agent 2) | 0.02 | parts by mass |
| Dextrorotatory chiral agent LC756 (manufactured by BASF) | adjusted according to a target reflection wavelength | |
| Polymerization initiator (IRGACURE OXE01, manufactured by BASF) | 1.0 | part by mass |

| | |
|---|---|
| Solvent (methyl ethyl ketone) | an amount to give a solute concentration of 20 mass % |

Mixture 1 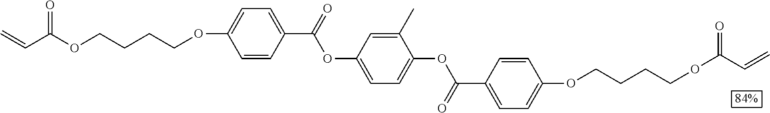 [SMILES: C=CC(=O)OCCCCOc1ccc(C(=O)Oc2ccc(OC(=O)c3ccc(OCCCCOC(=O)C=C)cc3)c(C)c2)cc1] 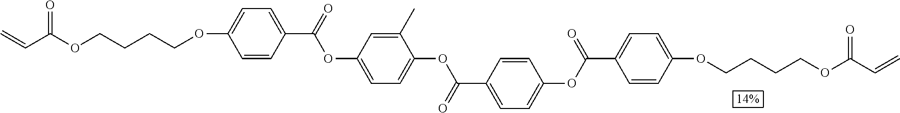 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1] 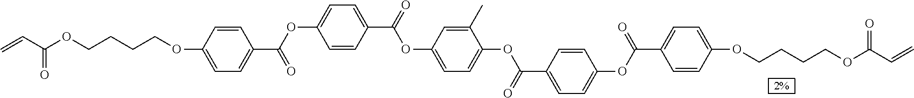 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
The numerical values are in mass %.
Alignment controlling agent 1 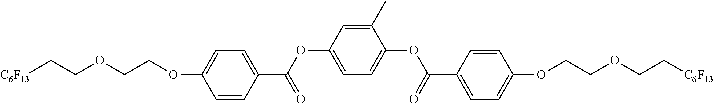
Alignment controlling agent 2

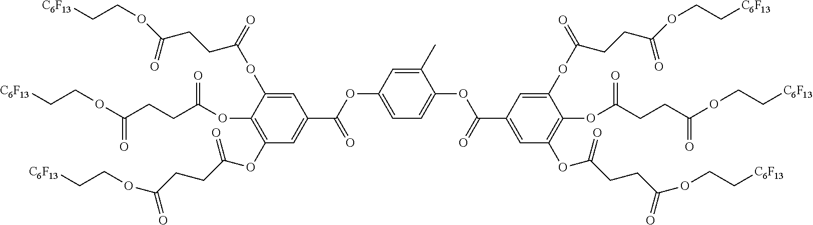

By adjusting the amount of the dextrorotatory chiral agent LC756 in this composition, the cholesteric liquid crystal layer-forming compositions 1 to 3 were prepared.

Using each of the cholesteric liquid crystal layer-forming compositions 1 to 3, a single cholesteric liquid crystal layer was formed on a support in the same manner as in the production of a selective reflection layer described later, and the reflection characteristics of light in the visible range were evaluated. The film thickness was as follows: the cholesteric liquid crystal layer-forming composition 1, 0.2 μm; the cholesteric liquid crystal layer-forming composition 2, 0.7 μm; the cholesteric liquid crystal layer-forming composition 3, 2 μm. The cholesteric liquid crystal layers formed were all right-handed circularly polarized light reflection layers. The selective reflection center wavelength at an incidence angle of 5° was as follows: the cholesteric liquid crystal layer-forming composition 1, 480 nm; the cholesteric liquid crystal layer-forming composition 2, 650 nm; the cholesteric liquid crystal layer-forming composition 3, 700 nm.

### Phase Difference Layer-Forming Composition

The following components were mixed to prepare a phase difference layer-forming composition having the following composition.

Phase difference layer-forming composition

| | |
|---|---|
| Mixture 1 | 100 parts by mass |
| Alignment controlling agent 1 | 0.05 parts by mass |
| Alignment controlling agent 2 | 0.01 parts by mass |
| Polymerization initiator IRGACURE | 1.0 part by mass |
| OXE01 (manufactured by BASF) | |
| Solvent (methyl ethyl ketone) | an amount to give a solute |
| | concentration of 20 mass % |

### Example 1

### Production of Projection Image Displaying Member

### Saponification of Cellulose Acylate Film

A 40 μm cellulose acylate film (TAC film) obtained by the same production method as in Example 20 in WO2014/112575A was passed through dielectric heating rolls at 60° C. to increase the film surface temperature to 40° C., after which an alkali solution having the following composition in an amount of 14 mL/m² was applied to one surface of the film using a bar coater and retained for 10 seconds under a steam-type far infrared heater (manufactured by Noritake Co., Ltd.) heated to 110° C.

Subsequently, pure water in an amount of 3 mL/m² was applied also using a bar coater.

Subsequently, washing with water using a fountain coater and dewatering using an air knife were repeated three times, and the film was then dried by being retained in a drying zone at 70° C. for 5 seconds to produce a saponified cellulose acylate film 1.

The in-plane retardation Re of the cellulose acylate film 1 was measured with an AxoScan and found to be 1 nm.

Alkali solution

| | |
|---|---|
| Potassium hydroxide | 4.7 parts by mass |
| Water | 15.7 parts by mass |
| Isopropanol | 64.8 parts by mass |
| Surfactant (C₁₆H₃₃O(CH₂CH₂O)₁₀H) | 1.0 part by mass |
| Propylene glycol | 14.9 parts by mass |

### Formation of Alignment Film

An alignment film-forming composition having the following composition in an amount of 24 mL/m² was applied to the saponified surface of the saponified cellulose acylate film 1 (resin layer) by using a wire bar coater and dried with hot air at 100° C. for 120 seconds.

Composition of alignment film-forming composition

| | | |
|---|---|---|
| Modified polyvinyl alcohol | 28 | parts by mass |
| Citric acid ester (AS3, manufactured by Sankyo Kagaku Yakuhin Co., Ltd.) | 1.2 | parts by mass |
| Photoinitiator (IRGACURE 2959, manufactured by BASF) | 0.84 | parts by mass |
| Glutaraldehyde | 2.8 | parts by mass |
| Water | 699 | parts by mass |
| Methanol | 226 | parts by mass |

Modified polyvinyl alcohol

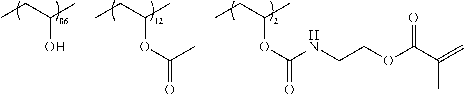

### Formation of Phase Difference Layer

On the surface of the alignment film formed on the cellulose acylate film 1, rubbing treatment (rayon cloth, pressure: 0.1 kgf (0.98 N), rotation speed: 1000 rpm (revolutions per minute), transport speed: 10 m/min, the number of reciprocating cycles: 1) was performed in a direction 45° rotated clockwise with respect to the longitudinal direction of the cellulose acylate film 1 as viewed from the alignment film surface, as schematically illustrated in FIG. 9.

In FIG. 9, H is the longitudinal direction of the cellulose acylate film 1, Sa is the direction of rubbing treatment, and the angle α is 45°.

The phase difference layer-forming composition was applied to the rubbed surface of the alignment film on the cellulose acylate film 1 by using a wire bar. The coating was then dried, placed on a hot plate at 50° C., and irradiated with ultraviolet light in an environment with an oxygen concentration of 1000 ppm or less by using an electrodeless lamp “D bulb” (60 mW/cm²) manufactured by Fusion UV Systems for 6 seconds to fix the liquid crystal phase, thereby obtaining a λ/4 layer serving as a polarization conversion layer.

The thickness of the λ/4 layer produced was measured with a noncontact thickness meter (manufactured by Filmetrics, F20) and found to be 0.7 μm.

The retardation of the phase difference layer produced was measured using an AxoScan and found to be 140 nm.

### Formation of Selective Reflection Layer

To the surface of the phase difference layer formed, the cholesteric liquid crystal layer-forming composition 1 was applied at room temperature using a wire bar so as to have a dry thickness of 0.2 μm, thereby forming a coating layer. The coating layer was dried at room temperature for 30 seconds, heated in an atmosphere at 85° C. for 2 minutes, and then irradiated with ultraviolet light in an environment with an oxygen concentration of 1000 ppm or less at 60° C. using a D bulb (lamp with 90 mW/cm²) manufactured by Fusion UV Systems at an output of 60% for 6 to 12 seconds to fix the cholesteric liquid crystalline phase, thereby obtaining a cholesteric liquid crystal layer having a thickness of 0.2 μm.

Next, the same process was repeatedly performed on the surface of the obtained cholesteric liquid crystal layer by further using the cholesteric liquid crystal layer-forming composition 2 to obtain a cholesteric liquid crystal layer having a thickness of 0.7 μm.

Next, the same process was repeatedly performed on the surface of the obtained cholesteric liquid crystal layer by further using the cholesteric liquid crystal layer-forming composition 3 to obtain a cholesteric liquid crystal layer having a thickness of 2 μm.

In this manner, a laminate A having the cellulose acylate film 1 having the alignment film, the phase difference layer, and the selective reflection layer constituted by the three cholesteric liquid crystal layers was obtained.

The reflection spectrum of the laminate A was measured with a spectrophotometer (manufactured by JASCO Corporation, V-670). The reflection spectrum obtained had selective reflection center wavelengths at 480 nm, 650 nm, and 700 nm at an incidence angle of 5°.

### Production of Transparent Substrate

A PET material was melted at 290° C. and extruded through a film-forming die into a sheet. The sheet was cooled by being brought into a close contact with a water-cooled rotary quenching drum to produce an unstretched film.

Using a biaxial stretching tester (manufactured by Toyo Seiki Seisaku-sho, Ltd.), the unstretched film was preheated at 120° C. for 1 minute and then stretched at a stretching ratio of 4.5 at 120° C. Thereafter, the resulting film was stretched at a stretching ratio of 1.5 in a direction perpendicular to the direction of the preceding stretching.

As a result, a transparent substrate having a refractive index in the slow axis direction of 1.70, a refractive index in the fast axis direction of 1.60, a thickness of 84 and an in-plane retardation Re at a wavelength of 550 nm of 8400 nm was produced. These were measured using an AxoScan.

The laminate A produced was bonded to the transparent substrate with an OCA (manufactured by Nichieikako Co., Ltd., MHM-UVC15). The bonding was performed with the cholesteric liquid crystal layers (selective reflection layer) facing the transparent substrate.

The bonding of the transparent substrate was performed such that an H direction of the alignment film on which the λ/4 layer was formed was assumed to be the vertical direction and that the angle of the slow axis of the transparent substrate with respect to the direction (horizontal direction) perpendicular to the H direction was 15°.

The resulting projection image displaying member was cut to a size of short side (length) 250 mm×long side (width) 280 mm, with the short side aligned with the vertical direction (H direction).

Thus, a projection image displaying member having the following layer structure was produced.

Transparent substrate/OCA/three cholesteric liquid crystal layers/λ/4 layer/TAC

### Production of Laminated Glass

A glass plate 300 mm long, 300 mm wide, and 2 mm thick (manufactured by Central Glass Co., Ltd., FL2, visible light transmittance: 90%) was provided.

On this glass plate, a 0.38-mm thick PVB film manufactured by Sekisui Chemical Co., Ltd. and cut to the same size was placed as an intermediate film.

On the intermediate film, the projection image displaying member in sheet form was placed with the phase difference layer side facing upward. The projection image displaying member and the glass plate were placed on each other with their long and short sides aligned.

On the projection image displaying member, a glass plate 300 mm long, 300 mm wide, and 2 mm thick (manufactured by Central Glass Co., Ltd., FL2, visible light transmittance: 90%) was placed.

This laminate was held at 90° C. and 10 kPa (0.1 atmospheres) for 1 hour and then heated in an autoclave (manufactured by Kurihara Seisakusho Co., Ltd.) at 115° C. and 1.3 MPa (13 atmospheres) for 20 minutes to remove air bubbles, thereby obtaining a laminated glass.

### Example 2

A projection image displaying member was produced in the same manner as in Example 1 except that the λ/4 layer serving as a polarization conversion layer was not formed.

The layer structure of the projection image displaying member produced is as follows.

Transparent Substrate/OCA/Three Cholesteric Liquid Crystal Layers/TAC

Using this projection image displaying member, a laminated glass was produced in the same manner as in Example 1.

When the λ/4 layer serving as a polarization conversion layer is not formed as in Example 2, the transparent substrate may be subjected to alignment treatment by rubbing or the like, and the cholesteric liquid crystal layers may be formed on the alignment-treated surface of the transparent substrate. In this case, since the OCA (adhesive layer) and the TAC (resin layer) need not be provided, the layer structure is “transparent substrate/three cholesteric liquid crystal layers”.

### Example 3

### Optical Rotation Layer-Forming Composition

The following components were mixed to prepare an optical rotation layer-forming composition having the following composition.

Optical rotation layer-forming composition

| | |
|---|---|
| Mixture 1 | 100 parts by mass |
| Alignment controlling agent 1 | 0.05 parts by mass |
| Alignment controlling agent 2 | 0.02 parts by mass |
| Dextrorotatory chiral agent LC756 | 0.47 parts by mass |
| (manufactured by BASF) | |
| Polymerization initiator IRGACURE | 1.0 part by mass |
| OXE01 (manufactured by BASF) | |
| Solvent (methyl ethyl ketone) | an amount to give a solute |
| | concentration of 20 mass % |

A projection image displaying member was produced in the same manner as in Example 1 except that this optical rotation layer-forming composition was used instead of the phase difference layer-forming composition, and an optical rotation layer serving as a polarization conversion layer was formed.

The thickness d of a helical structure can be expressed as “pitch P of helical structure x pitch number”. As described above, the pitch P of a helical structure refers to the length of one pitch in the helical structure. In a cholesteric liquid crystal layer, a selective reflection center wavelength λ is equal to “length P of one pitch x in-plane average refractive index n” (λ=P×n). Therefore, the pitch P is expressed as “selective reflection center wavelength λ/in-plane average refractive index n” (P=λ/n).

Hence, the polarization conversion layer-forming composition was prepared so as to have a selective reflection center wavelength λ of 5550 nm when formed into a cholesteric liquid crystal layer, and the coating thickness was set to 2.5 μm so that the pitch number would be 0.7.

The layer structure of the projection image displaying member produced is as follows.

Transparent Substrate/OCA/Three Cholesteric Liquid Crystal Layers/Optical Rotation Layer/TAC

Using this projection image displaying member, a laminated glass was produced in the same manner as in Example 1.

### Example 4

The same projection image displaying member as in Example 1 was produced. The layer structure is as follows.

Transparent Substrate/OCA/Three Cholesteric Liquid Crystal Layers/λ/4 Layer/TAC Production of Laminated Glass

A glass plate 300 mm long, 300 mm wide, and 2 mm thick (manufactured by Central Glass Co., Ltd., FL2, visible light transmittance: 90%) was provided.

On this glass plate, a 0.38-mm thick PVB film manufactured by Sekisui Chemical Co., Ltd. and cut to the same size was placed as an intermediate film.

On the intermediate film, a glass plate 300 mm long, 300 mm wide, and 2 mm thick (manufactured by Central Glass Co., Ltd., FL2, visible light transmittance: 90%) was placed.

This laminate was held at 90° C. and 10 kPa (0.1 atmospheres) for 1 hour and then heated in an autoclave (manufactured by Kurihara Seisakusho Co., Ltd.) at 115° C. and 1.3 MPa (13 atmospheres) for 20 minutes to remove air bubbles, thereby obtaining a laminated glass.

The projection image displaying member was bonded to one surface of the produced laminated glass with an OCA (manufactured by Nichieikako Co., Ltd., MHM-UVC15).

The projection image displaying member and the glass plate were bonded to each other with their long and short sides aligned.

### Example 5

The same projection image displaying member as in Example 2 was produced. The layer structure is as follows.

Transparent Substrate/OCA/Three Cholesteric Liquid Crystal Layers/TAC

This projection image displaying member was bonded to the same laminated glass as in Example 4 in the same manner as in Example 4.

### Example 6

A transparent substrate was produced in the same manner as in Example 1 except that the thickness of the transparent substrate was 60 μm. The in-plane retardation Re of the transparent substrate produced in the same manner as in Example 1 was measured and found to be 6000 nm.

A projection image displaying member was produced in the same manner as in Example 1 except that this transparent substrate was used. The layer structure is as follows.

Transparent Substrate/OCA/Three Cholesteric Liquid Crystal Layers/λ/4 Layer/TAC

This projection image displaying member was bonded to the same laminated glass as in Example 4 in the same manner as in Example 4.

### Example 7

A transparent substrate was produced in the same manner as in Example 1 except that the thickness of the transparent substrate was 100 μm. The in-plane retardation Re of the transparent substrate produced in the same manner as in Example 1 was measured and found to be 10000 nm.

A projection image displaying member was produced in the same manner as in Example 1 except that this transparent substrate was used. The layer structure of the projection image displaying member produced is as follows.

Transparent Substrate/OCA/Three Cholesteric Liquid Crystal Layers/λ/4 Layer/TAC

This projection image displaying member was bonded to the same laminated glass as in Example 4 in the same manner as in Example 4.

### Example 8

A projection image displaying member was produced in the same manner as in Example 1 except that the laminate A and the transparent substrate were bonded to each other such that the angle of the slow axis of the transparent substrate with respect to the direction (horizontal direction) perpendicular to the H direction (vertical direction) of the alignment film on which the λ/4 layer was formed was 40°. The layer structure of the projection image displaying member produced is as follows.

Transparent Substrate/OCA/Three Cholesteric Liquid Crystal Layers/λ/4 Layer/TAC

A laminated glass was produced in the same manner as in Example 1 except that this projection image displaying member was used.

### Comparative Example 1

A projection image displaying member was produced in the same manner as in Example 1 except that a TAC film having a thickness of 40 μM and an in-plane retardation Re of 1 nm was used instead of the transparent substrate. The layer structure of the projection image displaying member produced is as follows.

TAC/OCA/Three Cholesteric Liquid Crystal Layers/λ/4 Layer/TAC

A laminated glass was produced in the same manner as in Example 1 except that this projection image displaying member was used.

### Comparative Example 2

A transparent substrate was produced in the same manner as in Example 1 except that the thickness of the transparent substrate was 32 μm. The in-plane retardation Re was measured in the same manner as in Example 1 and found to be 3200 nm.

A projection image displaying member was produced in the same manner as in Example 1 except that this transparent substrate (PET) was used. The layer structure of the projection image displaying member produced is as follows.

PET/OCA/Three Cholesteric Liquid Crystal Layers/λ/4 Layer/TAC

A laminated glass was produced in the same manner as in Example 1 except that this projection image displaying member was used.

### Comparative Example 3

A projection image displaying member was produced in the same manner as in Example 1 except that the transparent substrate was not bonded. The layer structure of the projection image displaying member produced is as follows.

Three Cholesteric Liquid Crystal Layers/λ/4 Layer/TAC

A laminated glass was produced in the same manner as in Example 1 except that this projection image displaying member was used.

### Comparative Example 4

Using the same transparent substrate (PET with Re of 8400 nm) as in Example 1 instead of the cellulose acylate film, an alignment film, a λ/4 layer, and a selective reflection layer (three cholesteric liquid crystal layers) were formed in the same manner as in Example 1 to produce a projection image displaying member.

The relationship between the slow axis of the transparent substrate and the H direction of the alignment film was the same as in Example 1.

The layer structure of the projection image displaying member produced is as follows.

Three Cholesteric Liquid Crystal Layers/λ/4 Layer/Transparent Substrate

Using this projection image displaying member, a laminated glass was produced in the same manner as in Example 1.

The following evaluations were performed on the laminated glasses produced.

### Evaluation of Brightness

On the glass surface on the polarization conversion layer (λ/4 layer, optical rotation layer) side, p-polarized light was allowed to be incident from a direction of 65° with respect to the direction normal to the laminated glass, and the reflectivity spectrum of specularly reflected light was measured with a spectrophotometer (manufactured by JASCO Corporation, V-670). The specularly reflected light refers to reflected light in a direction of 65° with respect to the normal direction opposite to the incident direction in the incidence plane.

In the measurement, a linearly polarizing plate was disposed in a light receiving section of the spectrophotometer. The linearly polarizing plate was disposed such that the direction of the transmission axis was parallel to the direction of p-polarized light incident on the spectrophotometer. That is, this linearly polarizing plate acts as polarizing sunglasses.

The longitudinal direction (vertical direction) of the laminated glass was parallel to the direction of p-polarized light incident on the laminated glass. Therefore, the transmission axis of the λ/4 layer is at an angle of 45° with respect to s-polarized light and p-polarized light.

In accordance with JIS R 3106, a projection image reflectivity was calculated by multiplying a reflectivity by a coefficient based on luminosity and by an emission spectrum of a standard liquid crystal display device at wavelengths at 10-nm intervals in the range of 380 to 780 nm, and evaluated as brightness. The brightness was evaluated according to the following evaluation criteria.

A: projection image reflectivity of 25% or more

B: projection image reflectivity of 11% or more and less than 25%

C: projection image reflectivity of less than 11%

Grade A is a level at which a projection image can be clearly observed even under a clear sky.

Grade B is a level at which a projection image can be observed but is somewhat difficult to see under a clear sky.

Grade C is a level at which a projection image is difficult to see.

### Evaluation of Polarizing Sunglasses Suitability

On the glass surface on the transparent substrate side, s-polarized light was allowed to be incident from a direction of 65° with respect to the direction normal to the laminated glass, and p-polarized light transmitted through the laminated glass was measured with a spectrophotometer (manufactured by JASCO Corporation, V-670).

In the measurement, a linearly polarizing plate was disposed in a light receiving section of the spectrophotometer. The linearly polarizing plate was disposed such that the direction of the transmission axis and the direction of p-polarized light incident on the spectrophotometer were parallel to each other. That is, this linearly polarizing plate acts as polarizing sunglasses.

The transverse direction (horizontal direction) of the laminated glass was parallel to the direction of s-polarized incident on the laminated glass. Therefore, the transmission axis of the λ/4 layer is at an angle of 45° with respect to s-polarized light and p-polarized light.

In accordance with JIS R 3106, a visible light transmittance was calculated by multiplying a transmittance by a coefficient based on luminosity and by an emission spectrum of a D65 light source at wavelengths at 10-nm intervals in the range of 380 to 780 nm, and evaluated as polarizing sunglasses suitability. The polarizing sunglasses suitability was evaluated according to the following criteria.

Evaluation criteria for polarizing sunglasses suitability

A: less than 3%

B: 3% or more and less than 5%

C: 5% or more

The results are shown in the table below.

TABLE 1

| | | | | | | | | Evaluation items | |
|---|---|---|---|---|---|---|---|---|---|
| Configuration | | | | | | | | P- | |
| | Projection image displaying member | | Transparent substrate | | | Polarization | | polarized | Polarizing |
| | Layer structure | | | | Angle of | conversion layer | | light | sunglasses |
| | (right side is light incident side) | Location | Material | Re | slow axis | Type | Thickness | brightness | suitability |
| Example 1 | Transparent substrate/OCA/three | Between | PET | 8400 nm | 15° | λ/4 layer | 0.7 μm | A | A |
| | cholesteric liquid crystal layers/ | glasses | | | | | | | |
| | λ/4 layer/TAC | | | | | | | | |
| Example 2 | Transparent substrate/OCA/three | Between | PET | 8400 nm | 15° | None | — | B | A |
| | cholesteric liquid crystal layers/TAC | glasses | | | | | | | |
| Example 3 | Transparent substrate/OCA/three | Between | PET | 8400 nm | 15° | Optically | 2.5 μm | A | A |
| | cholesteric liquid crystal layers/ | glasses | | | | active | | | |
| | optical rotation layer/TAC | | | | | layer | | | |
| Example 4 | Transparent substrate/OCA/three | On glass | PET | 8400 nm | 15° | λ/4 layer | 0.7 μm | A | A |
| | cholesteric liquid crystal layers/λ/4 | surface | | | | | | | |
| | layer/TAC | | | | | | | | |
| Example 5 | Transparent substrate/OCA/three | On glass | PET | 8400 nm | 15° | None | — | B | A |
| | cholesteric liquid crystal layers/λ/4 | surface | | | | | | | |
| | layer/TAC | | | | | | | | |
| Example 6 | Transparent substrate/OCA/three | On glass | PET | 6000 nm | 15° | λ/4 layer | 0.7 μm | A | A |
| | cholesteric liquid crystal layers/λ/4 | surface | | | | | | | |
| | layer/TAC | | | | | | | | |
| Example 7 | Transparent substrate/OCA/three | On glass | PET | 10000 nm | 15° | λ/4 layer | 0.7 μm | A | A |
| | cholesteric liquid crystal layers/λ/4 | surface | | | | | | | |
| | layer/TAC | | | | | | | | |
| Example 8 | Transparent substrate/OCA/three | Between | PET | 8400 nm | 40° | λ/4 layer | 0.7 μm | A | B |
| | cholesteric liquid crystal layers/λ/4 | glasses | | | | | | | |
| | layer/TAC | | | | | | | | |
| Comparative | TAC/OCA/three cholesteric liquid | Between | TAC | 1 nm | 15° | λ/4 layer | 0.7 μm | A | C |
| Example 1 | crystal layers/λ/4 layer/TAC | glasses | | | | | | | |
| Comparative | PET/OCA/three cholesteric liquid | Between | PET | 3200 nm | 15° | λ/4 layer | 0.7 μm | A | C |
| Example 2 | crystal layers/λ/4 layer/TAC | glasses | | | | | | | |
| Comparative | Three cholesteric liquid crystal | Between | None | — | — | λ/4 layer | 0.7 μm | A | C |
| Example 3 | layers/λ/4 layer/TAC | glasses | | | | | | | |
| Comparative | Three cholesteric liquid crystal | Between | PET | 8400 nm | 15° | λ/4layer | 0.7 μm | C | B |
| Example 4 | layers/λ/4 layer/transparent substrate | glasses | | | | | | | |

The angle of the slow axis of a high-Re substrate is an angle with respect to s-polarized light (horizontal direction).
The λ/4 layer has a Re of 140 nm, and the angle of the slow axis of the λ/4 layer with respect to s-polarized light and p-polarized light is 45°.
The optical rotation layer has a pitch number of 0.7 and has a selective reflection center wavelength of 5550 nm when regarded as a cholesteric liquid crystal layer.

As shown in the above table, according to the projection image displaying members of the present invention, each having a transparent substrate on the side on which external light is incident, the amount of p-polarized light component incident on the transparent substrate side and transmitted through the projection image displaying member can be reduced, and high polarizing sunglasses suitability is provided in, for example, a HUD.

In particular, as shown by Example 1 and Example 8, when the projection image displaying member has a λ/4 layer as a polarization conversion layer, better polarizing sunglasses suitability is provided by setting the angle formed by the slow axis of the transparent substrate and s-polarized light (horizontal direction) to 30° or less. As shown by Examples 1 and 2 and Examples 4 and 5, the presence of a polarization conversion layer in the projection image displaying member can improve the p-polarized light brightness, that is, the display brightness of a HUD.

By contrast, Comparative Example 1, in which a TAC film having an in-plane retardation Re of 1 nm was used instead of the transparent substrate, Comparative Example 2, in which a PET substrate having an in-plane retardation Re of 3200 nm was used, and Comparative Example 3, in which no substrate was provided on the external light incident side, have low polarizing sunglasses suitability, and when they are used in a HUD, glare that interferes with driving cannot be blocked by polarizing sunglasses. In Comparative Example 4, in which the transparent substrate is located on the side on which projection light is incident, the p-polarized light brightness, that is, the display brightness of a HUD, is low.

From the above results, the advantageous effects of the present invention are apparent.

The present invention can be suitably used for, for example, an in-vehicle HUD.

### REFERENCE SIGNS LIST

10 projection image displaying member
12 transparent substrate
14 selective reflection layer
14R red-reflecting cholesteric liquid crystal layer
14G green-reflecting cholesteric liquid crystal layer
14B blue-reflecting cholesteric liquid crystal layer
16 polarization conversion layer
18 adhesive layer
20A, 20B, 20C windshield glass
24a first glass plate
24b second glass plate
26 intermediate film
30 HUD
32 projector
34 screen image forming unit
36 intermediate image screen
38 mirror
40 concave mirror
42 dashboard
46 transmission window
50 LCD (liquid crystal display)
52 projection lens
O driver

What is claimed is:

1. A projection image displaying member comprising:
a transparent substrate having an in-plane retardation of 5000 nm or more; and
at least one selective reflection layer,
wherein the selective reflection layer is located closer to a side on which projection light is incident than the transparent substrate is.

2. The projection image displaying member according to claim 1, comprising a polarization conversion layer that converts linearly polarized light into circularly polarized light or changes a polarization direction of linearly polarized light,
wherein the transparent substrate, the selective reflection layer, and the polarization conversion layer are disposed in this order.

3. The projection image displaying member according to claim 2, wherein the polarization conversion layer is a phase difference layer having an in-plane phase difference of 100 to 450 nm at a wavelength of 550 nm.

4. The projection image displaying member according to claim 2, wherein the polarization conversion layer is a layer formed by fixing a helical alignment structure of a liquid crystal compound twistedly aligned along a helical axis extending in a thickness direction.

5. The projection image displaying member according to claim 4, wherein at least one of (i) or (ii) is satisfied:
$$\begin{matrix}0.2 \leq x \leq 1.5 & ( i ) \\ 1.0 \leq y \leq 5.0 & ( ii )\end{matrix}$$
where x is a pitch number of the helical alignment structure, and y is a thickness (μm) of the polarization conversion layer.

6. The projection image displaying member according to claim 1, wherein the selective reflection layer is a cholesteric liquid crystal layer formed by fixing a cholesteric liquid crystalline phase.

7. The projection image displaying member according to claim 1, wherein an angle formed by incident s-polarized light and a slow axis of the transparent substrate is 10° to 30°.

8. A windshield glass comprising:
a first glass plate and a second glass plate that are bonded together; and
the projection image displaying member according to claim 1.

9. The windshield glass according to claim 8, wherein the projection image displaying member is disposed between the first glass plate and the second glass plate.

10. The windshield glass according to claim 8, wherein the projection image displaying member is bonded to a surface of the first glass plate facing away from the second glass plate.

11. The windshield glass according to claim 8, wherein the first glass plate is on a vehicle interior side, and the projection image displaying member is disposed such that the transparent substrate is closer to the second glass plate than the selective reflection layer is.

12. The windshield glass according to claim 8, wherein an angle formed by a horizontal direction in a mounted state and a slow axis of the transparent substrate of the projection image displaying member is 10° to 30°.

13. A head-up display system comprising:
the windshield glass according to claim 8; and
a projector that projects p-polarized projection light onto the windshield glass.

14. The projection image displaying member according to claim 2, wherein the selective reflection layer is a cholesteric liquid crystal layer formed by fixing a cholesteric liquid crystalline phase.

15. The projection image displaying member according to claim 2, wherein an angle formed by incident s-polarized light and a slow axis of the transparent substrate is 10° to 30°.

16. A windshield glass comprising:
a first glass plate and a second glass plate that are bonded together; and
the projection image displaying member according to claim 2.

17. The windshield glass according to claim 16, wherein the projection image displaying member is disposed between the first glass plate and the second glass plate.

18. The windshield glass according to claim 16, wherein the projection image displaying member is bonded to a surface of the first glass plate facing away from the second glass plate.

19. The windshield glass according to claim 9, wherein the first glass plate is on a vehicle interior side, and the projection image displaying member is disposed such that the transparent substrate is closer to the second glass plate than the selective reflection layer is.

20. The windshield glass according to claim 9, wherein an angle formed by a horizontal direction in a mounted state and a slow axis of the transparent substrate of the projection image displaying member is 10° to 30°.
